(19) United States
(12) Patent Application Publication
(10) Pub. No.: US 2026/0202847 A1
(43) Pub. Date: Jul. 16, 2026

(54) NONLINEAR HARMONIC DISTURBANCE OBSERVER AND ROBUST CONTROLLER FOR UAVS

(71) Applicant: KING FAHD UNIVERSITY OF PETROLEUM AND MINERALS, Dhahran (SA)

(72) Inventors: Muhammad KHALID, Dhahran (SA); Kamran ZEB, Dhahran (SA)

(73) Assignee: KING FAHD UNIVERSITY OF PETROLEUM AND MINERALS, Dhahran (SA)

(21) Appl. No.: 19/176,012

(22) Filed: Apr. 10, 2025

Related U.S. Application Data
(60) Provisional application No. 63/745,604, filed on Jan. 15, 2025.

(51) Int. Cl. G05D 1/495; B64U 50/13; G05D 1/46; G05D 1/48; G05D 109/25

(52) U.S. Cl. CPC G05D 1/495; B64U 50/13; G05D 1/46; G05D 1/48; B64U 2201/20; G05D 2109/254

(57) ABSTRACT

A system and method for controlling an unmanned aerial vehicle (UAV) including a plurality of propellers. The method comprises setting an initial rotational speed of each propeller, obtaining a control input including desired state trajectories, and determining an altitude-and-attitude control action based on an X-orientation model. The X-orientation model includes an input-to-state feedback linearization, an estimated disturbance, and the control input. The altitude-and-attitude control action is changed to incorporate a first supertwisting controller and a first sliding surface. A position X-Y control action is determined based on the desired state trajectories and the X-orientation model. The position X-Y control action includes a second supertwisting controller and a second sliding surface. A required rotational speed of each propeller is determined based on the altitude-and-attitude control action and the position X-Y control action. The initial rotational speed of each propeller is changed to the required rotational speed.

### CROSS-REFERENCE TO RELATED APPLICATIONS

The present application claims priority to U.S. Provisional Application No. 63/745,604, filed Jan. 15, 2025, the entire content of which is incorporated by reference herein in its entirety for all purposes.

### STATEMENT OF PRIOR DISCLOSURE BY AN INVENTOR

Aspects of the present disclosure were described in Sadiq, M., Hayat, R., Zeb, K., Al-Durra, A. & Ullah, A. Robust Feedback Linearization Based Disturbance Observer Control of Quadrotor UAV. IEEE Access. 12, 17966-17981 (2024), incorporated herein by reference in its entirety.

### STATEMENT OF ACKNOWLEDGEMENT

Support provided by the Technology ICT Endowment Scholarship under project 10.13039/501100007278 at the National University of Sciences, and the CRUI CARE Agreement under project 10.13039/501100006690 at the Politecnico di Milano, is gratefully acknowledged.

### BACKGROUND

### Technical Field

The present disclosure is directed to a robust feedback linearization-based disturbance observer control system for an unmanned aerial vehicle (UAV).

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Quadrotor UAVs have gained significant traction in recent years due to their versatility in various applications, including aerial surveillance, autonomous delivery, and environmental monitoring. These UAVs operate in dynamic environments where they are frequently subjected to external disturbances, such as wind gusts, unmodeled aerodynamic effects, and payload variations. Consequently, ensuring precise altitude and attitude control while mitigating external disturbances remains a critical challenge for UAV control systems.

Several approaches have been proposed for robust quadrotor control. One of the most widely explored techniques involves feedback linearization, a nonlinear control method that transforms the nonlinear dynamics of a system into an equivalent linear system, facilitating conventional linear control strategies. However, conventional feedback linearization methods often lack robustness in the presence of unmodeled disturbances and external perturbations. To address such stability issues, several control techniques have been implemented. Sliding Mode Control (SMC) is a widely used robust control method that ensures finite-time convergence, making it resilient to modeling inaccuracies and disturbances [See: N. Prayongpun and K. Raoof, “Impact of depolarization phenomena on polarized MIMO channel performances,” published in International Journal of Communications, Network and System Sciences, vol. 1, 2008, doi: 10.4236/ijcns.2008.12016].

However, SMC suffers from chattering, leading to excessive actuator wear. To mitigate this issue, Terminal Sliding Mode Control (TSMC) has been developed, offering finite-time convergence with reduced chattering effects [See: S. Ghobrial and S. Sharief, “Microwave Attenuation and Cross Polarization in Dust Storms,” published in IEEE Transactions on Antennas and Propagation, vol. 35, pp. 418-425, 1987, doi: 10.1109/TAP.1987.1144120]. Additionally, Adaptive Backstepping Sliding Mode Control (ABSMC) with disturbance observers has been employed to improve disturbance estimation accuracy. However, these methods tend to have long settling times for disturbance estimation.

CN113359472A discloses a quadrotor UAV robust trajectory tracking control method that utilizes an adaptive estimation algorithm to compensate for the gyroscopic effect and wind resistance. This system dynamically adjusts the estimated values of rotor parameters to improve precision and stability in trajectory tracking. However, while this method mitigates external disturbances, it does not incorporate nonlinear disturbance observer techniques to estimate and reject time-varying disturbances effectively.

CN117784808A describes a position loop linear extended state observer coupled with a sliding mode controller for UAV disturbance observation and fixed-point control. This system improves robustness against bounded disturbances by estimating disturbance forces in real time and feeding them back into the control loop. However, the approach lacks input-to-state feedback linearization, which could further enhance control accuracy by transforming the UAV's nonlinear dynamics into a simplified control model.

Existing solutions for robust UAV control remain inadequate in addressing the full spectrum of disturbances encountered in real-world conditions. Traditional sliding mode controllers, while robust, suffer from chattering effects, leading to excessive control effort and actuator wear. Furthermore, standard nonlinear disturbance observers often assume constant or slowly varying disturbances, limiting their effectiveness in environments with rapid disturbance fluctuations.

Accordingly, it is one object of the present disclosure to overcome the drawbacks of the existing solution by improving stability, mitigating external disturbances, and providing accurate trajectory tracking. The present invention overcomes the limitations of prior art by integrating feedback linearization with advanced disturbance rejection techniques, offering improved robustness and stability for quadrotor UAVs operating in uncertain environments.

### SUMMARY

In an embodiment, a method for controlling an unmanned aerial vehicle (UAV) including a plurality of propellers is disclosed. The method includes setting an initial rotational speed of each propeller of the plurality of propellers, obtaining a control input including a plurality of desired state trajectories from a user, and determining an altitude-and-attitude control action based on an X-orientation model including an input-to-state feedback linearization, an estimated disturbance, and the control input. The altitude-and-attitude control action comprises a z-direction control, a roll control, a pitch control, and a yaw-axis control. The control input is modified to include a first supertwisting controller and a first sliding surface. The method further includes determining a position X-Y control action based on the plurality of desired state trajectories and the X-orientation model with a second supertwisting controller and a second sliding surface, determining a required rotational speed of each propeller of the plurality of propellers based on the altitude-and-attitude control action and the position X-Y control action, and changing the initial rotational speed of each propeller of the plurality of propellers to the required rotational speed of each propeller of the plurality of propellers to control the UAV.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic diagram of an unmanned aerial vehicle (UAV) system, according to certain embodiments.

FIG. 1B is a flowchart illustrating a method for controlling a UAV including a plurality of propellers, according to certain embodiments.

FIG. 1C is a schematic diagram of a quadrotor aircraft system implementing trajectory-tracking control, according to certain embodiments.

FIG. 2 is a block diagram illustrating a trajectory-tracking control system for the UAV, according to certain embodiments.

FIG. 3 is a graph illustrating a trajectory-tracking response along the x-axis of the UAV employing a proportional-derivative control technique, according to certain embodiments.

FIG. 4 is a graph illustrating a trajectory-tracking response along the y-axis of the UAV employing the proportional-derivative control technique, according to certain embodiments.

FIG. 5 is a graph illustrating a trajectory-tracking response along the x-axis of the UAV employing a second-order sliding mode control technique, according to certain embodiments.

FIG. 6 is a graph illustrating a trajectory-tracking response along the y-axis of the UAV employing the second-order sliding mode control technique, according to certain embodiments.

FIG. 7 is a graph illustrating a trajectory-tracking error response along the x-axis in the quadrotor helicopter control system, according to certain embodiments.

FIG. 8 is a graph illustrating a trajectory-tracking error response along the y-axis in the quadrotor helicopter control system, according to certain embodiments.

FIG. 9A is a graph illustrating an x-axis trajectory tracking response of the UAV under a finite-time super twisting sliding mode controller, according to certain embodiments.

FIG. 9B is a graph illustrating a y-axis trajectory tracking response of the UAV under the finite-time super twisting sliding mode controller, according to certain embodiments.

FIG. 9C is a graph illustrating a z-axis trajectory tracking response of the UAV under the finite-time super twisting sliding mode controller, according to certain embodiments.

FIG. 9D is a graph illustrating a yaw angle trajectory tracking response of the UAV under the finite-time super twisting sliding mode controller, according to certain embodiments.

FIG. 10A is a graph illustrating thrust control force response during multi-step input trajectory tracking, according to certain embodiments.

FIG. 10B is a graph illustrating roll control torque response during multi-step input trajectory tracking, according to certain embodiments.

FIG. 11A is a graph illustrating pitch control torque response during multi-step input trajectory tracking, according to certain embodiments.

FIG. 11B is a graph illustrating yaw control torque response during multi-step input trajectory tracking, according to certain embodiments.

FIG. 12 is a three-dimensional plot illustrating a circular trajectory tracking of a UAV system, according to certain embodiments.

FIG. 13A is a graph illustrating thrust control force response during circular trajectory tracking, according to certain embodiments.

FIG. 13B is a graph illustrating roll control torque response during circular trajectory tracking, according to certain embodiments.

FIG. 14 is a graph illustrating pitch control torque response during circular trajectory tracking, according to certain embodiments.

FIG. 15 is a three-dimensional plot illustrating an infinity-shaped trajectory tracking of the UAV system, according to certain embodiments.

FIG. 16A is a graph illustrating thrust control force response during infinity-shaped trajectory tracking, according to certain embodiments.

FIG. 16B is a graph illustrating roll control torque response during infinity-shaped trajectory tracking, according to certain embodiments.

FIG. 17 is a graph illustrating pitch control torque response during infinity-shaped trajectory tracking, according to certain embodiments.

FIG. 18 is a three-dimensional plot illustrating a square-shaped trajectory tracking of a UAV system, according to certain embodiments.

FIG. 19A is a graph illustrating thrust control force response during square-shaped trajectory tracking, according to certain embodiments.

FIG. 19B is a graph illustrating roll control torque response during square-shaped trajectory tracking, according to certain embodiments.

FIG. 20 is a graph illustrating pitch control torque response during square-shaped trajectory tracking, according to certain embodiments.

FIG. 21 is a three-dimensional plot illustrating a spiral trajectory tracking of a UAV system, according to certain embodiments.

FIG. 22A is a graph illustrating thrust control force response during spiral trajectory tracking, according to certain embodiments.

FIG. 22B is a graph illustrating roll control torque response during spiral trajectory tracking, according to certain embodiments.

FIG. 23 is a graph illustrating pitch control torque response during spiral trajectory tracking, according to certain embodiments.

FIG. 24 is a three-dimensional plot comparing the RFBL controller performance in simulation and hardware-in-the-loop environments during circular trajectory tracking, according to certain embodiments.

FIG. 25A is a graph illustrating thrust control force response of the RFBL controller in simulation and hardware-in-the-loop environments, according to certain embodiments.

FIG. 25B is a graph illustrating roll control torque response of the RFBL controller in simulation and hardware-in-the-loop environments, according to certain embodiments.

FIG. 25C is a graph illustrating pitch control torque response of the RFBL controller in simulation and hardware-in-the-loop environments, according to certain embodiments.

FIG. 26 is an illustration of a non-limiting example of details of computing hardware used in the computing system, according to certain embodiments.

FIG. 27 is an exemplary schematic diagram of a data processing system used within the computing system, according to certain embodiments.

FIG. 28 is an exemplary schematic diagram of a processor used with the computing system, according to certain embodiments.

FIG. 29 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

Aspects of this disclosure address the challenge of UAV trajectory tracking and stability under external disturbances. By implementing a nonlinear second-order sliding mode control scheme with supertwisting controllers for an X-orientation model, the current disclosure improves trajectory accuracy, stability, and disturbance rejection, resulting in robust UAV performance in dynamic environments.

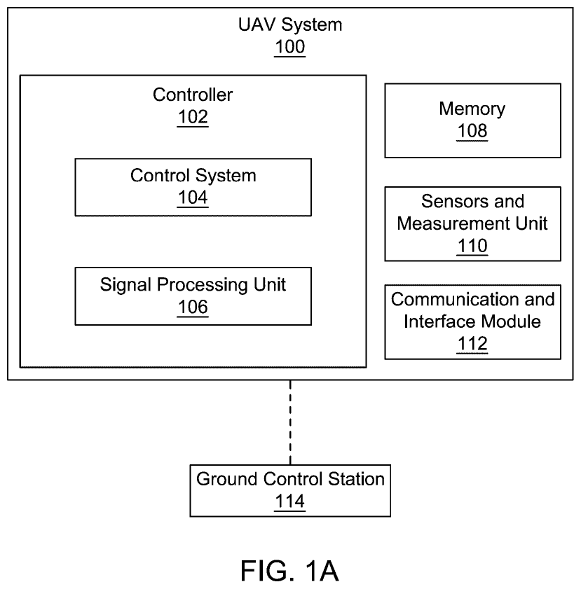

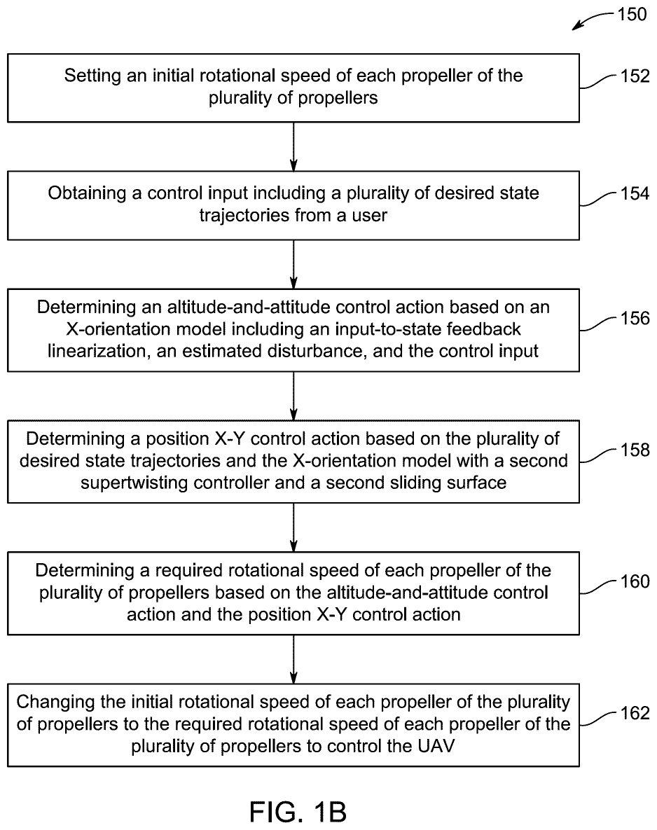

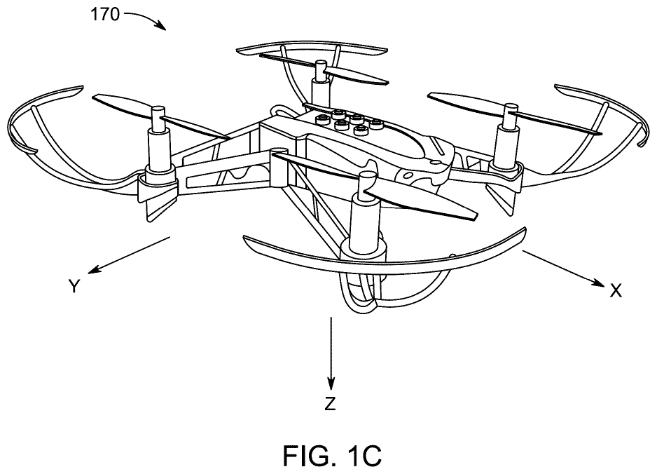

FIG. 1A illustrates an unmanned aerial vehicle (UAV) system 100 configured to execute altitude-and-attitude control actions and position X-Y control actions based on a robust feedback linearization (RFBL) controller and supertwisting controllers for trajectory tracking and disturbance rejection. The UAV system 100 integrates a control architecture that processes sensor inputs, determines necessary control actions, and adjusts flight parameters in real time for precise trajectory tracking and disturbance rejection. The UAV system 100 is applicable to a wide range of aerial applications, including autonomous navigation, aerial surveillance, precision agriculture, environmental monitoring, search and rescue operations, and industrial inspections.

UAVs utilize propellers as the primary means of propulsion and maneuverability. A propeller is a rotating airfoil that generates thrust by accelerating air backward, enabling the UAV to achieve lift, forward motion, and directional control. UAVs are designed with different configurations based on the number of propellers. Examples include a bicopter having two propellers, a tricopter having three propellers in Y-shaped configuration, a quadcopter arranged in X-shape, a hexacopter having six propellers arranged in a hexagonal pattern, and an octacopter having eight propellers arranged in a circular or coaxial setup.

In one embodiment of the present disclosure, the UAV system 100 is configured for a quadcopter configuration having four propellers arranged in X orientation. The UAV system 100 comprises various components, including a controller 102, a memory 108, a sensors and measurement unit 110, and a communication and interface module 112. The system components collectively render real-time data processing, storage, and bidirectional communication with external systems.

The controller 102 serves as a central processing unit for managing all control operations within the UAV system 100 and is configured for executing flight control commands, processing sensor data, and dynamically adjusting trajectory parameters based on real-time feedback. The controller 102 integrates multiple processing components to facilitate high-speed computational efficiency and parallel data processing. The controller 102 may be implemented using various processing architectures, including central processing units (CPUs), digital signal processors (DSPs), graphics processing units (GPUs), field-programmable gate arrays (FPGAs), application-specific integrated circuits (ASICs), and system-on-chip (SoC) architectures. In certain embodiments, the controller 102 utilizes complex programmable logic devices (CPLDs) to enhance adaptive control computations, while ASIC-based controllers provide hardware-optimized control functions for UAV stability and navigation. The controller 102 processes incoming sensor data, executes control loops, and transmits actuation signals to motor control units.

The controller 102 includes or is operably connected to a control system 104, which includes a first supertwisting controller for generating altitude-and-attitude control actions, a second supertwisting controller for generating position X-Y control actions, a RFBL model, and a nonlinear harmonic disturbance observer (NHDO) for dynamically adjusting flight control parameters to reject disturbances for improving trajectory accuracy.

The control system 104 is configured to set an initial rotational speed of each propeller of the UAV. The initial rotational speed refers to the predefined or default speed at which the propellers of the UAV begin rotating when powered on or before a control input is applied for active maneuvering. The control input comprises multiple predefined trajectories specifying how the UAV should behave or move during operation. These trajectories define the desired flight paths or motions for the UAV, including parameters such as position coordinates (X, Y) in horizontal plane, altitude (Z), orientation parameters (roll, pitch, yaw), velocity and acceleration profiles, specifying how fast and with what acceleration the UAV should move or change its orientation over time.

The control input is typically provided by a user through the ground control station 114. From the ground control station 114, the control input can be transmitted to the communication and interface module 112 of the UAV system 100. The control system 104 then obtains the control input, including a plurality of desired state trajectories from a user, from the communication and interface module 112. The plurality of desired state trajectories refers to multiple predefined motion paths or target states that a user specifies for the UAV or any autonomous system to follow during its operation. These trajectories define the expected movement of the UAV in terms of position, velocity, acceleration, altitude, and orientation over time. The control system 104 receives real-time state data, corresponding to including position, altitude, velocity, and attitude information, from onboard sensors and external navigation modules.

Based on the received control input, the control system 104 then determines an altitude-and-attitude control action. The altitude-and-attitude control action is based on an X-orientation model. The X-orientation model governs the UAV positioning, attitude control, and trajectory tracking by implementing a structured control based on an input-to-state feedback linearization framework and an estimated disturbance. The X-orientation model is designed to process a plurality of virtual control inputs configured to control the motions such as sensor inputs, generate control actions, and regulate flight parameters in real-time under a fully actuated system. The virtual control inputs serve as intermediate control signals that define the desired UAV behavior before being translated into physical control commands for the UAV actuators. In an embodiment, the X-orientation model represents the flight dynamics and control strategy for the UAV, particularly a quadcopter, configured in an X-frame propeller arrangement. The X-orientation model is applied to a quadcopter UAV, where the four propellers are arranged in an X-configuration, meaning that when viewed from above, the UAV resembles an “X” shape.

The altitude-and-attitude control action comprises a z-direction control, a roll control, a pitch control, and a yaw-axis control. In one aspect, in addition to the control input, the control system 104 includes an input-to-state feedback linearization and an estimated disturbance for determining the altitude-and-attitude control action.

The input-to-state feedback linearization is a control technique used in nonlinear control systems, such as UAV dynamics, where a nonlinear system is mathematically transformed into an equivalent linear system through state-space transformations and feedback of system states. The input-to-state feedback linearization is specifically achieved by applying the RFBL controller for mathematical computation. The RFBL controller considers the UAV dynamics through a nonlinear model including states, such as position, velocity, orientation, angular rates, and nonlinearities, such as rotational dynamics, aerodynamic effects, gravitational forces, for mathematical computation of the input-to-state feedback linearization.

The RFBL controller integrated within the control system 104 is a control methodology designed to significantly enhance UAV stability and tracking precision. The RFBL controller linearizes the inherently nonlinear dynamics of the UAV, enabling the efficient application of linear control techniques. Specifically, the RFBL controller is integrated with two additional robust controllers, first, an Integral Sliding Mode Controller (ISMC) and second, a Terminal Synergetic Controller (TSC). The ISMC is implemented for its inherent ability to provide robustness against uncertainties and disturbances through integral action and sliding mode behavior, ensuring consistent performance in varying conditions. The TSC contributes by providing finite-time stability through a synergistic control strategy, providing rapid convergence to the desired flight trajectories.

The estimated disturbance refers to the quantified approximation or prediction of external or internal forces and influences acting on the UAV, which may negatively affect its trajectory accuracy, stability, and overall performance. The disturbances can be aerodynamics disturbances, environmental conditions, mechanical uncertainties, unmodeled dynamics, and the like. The NHDO is configured to estimate external disturbances acting on the UAV by analyzing harmonic frequency components of external forces, including aerodynamic disturbances, wind gusts, and actuator uncertainties. The NHDO receives real-time flight state data and external force parameters, processes the information using a two-state ordinary differential equation, and generates disturbance estimates that are transmitted to the control system 104. Based on the estimated disturbance parameters, the NHDO dynamically modifies control actions to reject disturbances with predetermined frequency component to enhance stability and flight precision of the UAVs. The NHDO implementation prevents trajectory accuracy getting affected by fluctuating aerodynamic loads, motor vibrations, and sudden environmental changes.

In one implementation, the control input provided by the user is modified by integrating the control input with a first supertwisting controller and a first sliding surface for altitude-and-attitude control, and a second supertwisting controller and second sliding surface for horizontal position control.

The first supertwisting controller integrated in the control system 104 is configured for generating altitude-and-attitude control actions, including control actions in the vertical, i.e. z-direction, and angular orientations, such as roll, pitch, and yaw. The first supertwisting controller continuously compares real-time sensor measurements provided by the sensors and measurement Unit 110, such as altitude, roll, pitch, and yaw data, against the desired trajectory inputs obtained from the user. Based on the differences identified, the first supertwisting controller dynamically generates corrective control signals aimed at minimizing deviations from the desired altitude and orientation states.

The first sliding surface works in conjunction with the first supertwisting controller to regulate altitude-and-attitude of the UAV towards stability and desired trajectories. The sliding surface acts as a virtual reference line or boundary representing the desired state of UAV orientation and altitude. Deviations from this surface trigger the corrective action from the first supertwisting controller renders swift and stable convergence of the UAV's actual flight state back to the predefined trajectory.

Further, the second supertwisting controller within the control system 104 determines a position X-Y control action based on the plurality of desired state trajectories and the X-orientation model. The desired state trajectories provided by the user via the ground control station 114, are compared with real-time position data obtained from sensors such as GPS and IMUs, integrated within the sensors and measurement Unit 110. The second supertwisting controller dynamically determines adjustments needed to align actual position of the UAV accurately with the designated horizontal flight path, compensating proactively for environmental disturbances such as wind gusts or aerodynamic fluctuations. The control system 104 continuously adapts flight parameters based on feedback from sensors and actuators.

The second sliding surface functions in conjunction with the second supertwisting controller, serving as a reference boundary to gauge deviations of actual position of the UAV from the desired horizontal trajectory. When the UAV position drifts from this predefined surface, the second supertwisting controller rapidly responds by generating position-corrective control actions.

The control system 104 is further configured to determine a required rotational speed of each propeller of the plurality of propellers based on the altitude-and-attitude control action and the position X-Y control action, as determined by the first supertwisting controller and the second supertwisitng controller, respectively. Based on the computed required rotational speed of each propeller, the initial rotational speed of each propeller is changed to the required rotational speed of each propeller to control the UAV.

The controller 102 further includes a signal processing unit 106. The signal processing unit 106 receives sensor data from the sensors and measurement unit 110 having multiple onboard measurement modules, including inertial measurement units (IMUs), global positioning system (GPS) modules, barometers, magnetometers, and optical flow sensors. The signal processing unit 106 applies noise filtering techniques, performs sensor fusion operations, and extracts flight parameters required for control computations. The processed sensor data is transmitted to the control system 104, which utilizes the information to generate control signals for adjusting UAV motion parameters. The signal processing unit 106 is configured to detect anomalies in sensor readings, correct inconsistencies, for accurate state estimation of the control system operation. The signal processing unit 106 integrates filtering techniques such as Kalman filtering, complementary filtering, and adaptive thresholding to refine sensor data, ensuring that trajectory computations remain robust against measurement errors.

The memory 108 is configured to store flight control parameters, sensor calibration data, predefined flight trajectories, and real-time operational logs required for adaptive control execution. The memory 108 interfaces with the controller 102, control system 104, signal processing unit 106, and NHDO to facilitate real-time data storage and retrieval, ensuring seamless computational execution. The memory 108 may be implemented using various types of storage architectures, including volatile memory, non-volatile memory, distributed storage systems, and removable storage devices. In certain embodiments, the memory 108 includes random access memory (RAM) for real-time control computations, solid-state drives (SSDs) for high-speed storage of UAV flight logs, and flash memory for firmware updates and system configurations. The memory 108 may also include read-only memory (ROM), electronically erasable programmable read-only memory (EEPROM), magnetic storage devices, and optical storage media. In certain configurations, the memory 108 is integrated with NoSQL databases, MySQL architectures, and distributed cloud-based storage systems, enabling secure data backup and remote access to UAV telemetry and control datasets. The memory 108 stores predefined flight paths, sensor calibration data, control system parameters, and real-time flight logs required for adaptive control execution. The stored flight trajectories are accessed by the control system 104 to generate control actions that align the UAV motion with predefined paths.

In one implementation, the sensors and measurement unit 110 includes a plurality of sensors to continuously acquire real-time state data, including position, altitude, velocity, and orientation of the UAV. The sensors and measurement unit 110 comprises various types of sensors, IMUs, GPS modules, barometric altimeters, magnetometers, optical flow sensors, and lidar sensors. The IMUs provide acceleration and angular velocity data. The GPS modules determine the UAV's global position coordinates, facilitating autonomous navigation and trajectory tracking. The barometric altimeters measure atmospheric pressure to estimate altitude variations. The magnetometers detect magnetic field variations to determine the UAV's heading direction. The optical flow sensors analyze image patterns to estimate relative motion. The lidar sensors generate high-resolution depth maps by measuring distances to surrounding objects.

The sensors and measurement unit 110 then transmits the acquired data to the signal processing unit 106, which performs necessary computational adjustments before forwarding the processed data to the control system 104. The communication and interface module 112 facilitates data exchange between the UAV system 100 and the external ground control station 114. The communication and interface module 112 supports bidirectional data transmission, enabling the UAV to receive control commands from the ground control station 114 while transmitting real-time telemetry and diagnostic information for remote monitoring.

The ground control station 114 receives telemetry data, monitors UAV system health, and transmits updated trajectory commands to the UAV system 100. The ground control station 114 may be implemented as a fixed control center, a mobile ground station, or an autonomous mission management system deployed in remote field operations. The ground control station 114 interfaces with external communication networks, including satellite links, cellular networks, and cloud-based data platforms, enabling remote operators to oversee UAV operations from geographically distributed locations. The ground control station 114 transmits updated target trajectories to the controller 102, which processes received inputs, computes necessary control adjustments, and transmits actuation signals to UAV propulsion and flight control subsystems.

FIG. 1B illustrates a method 150, implemented by the system 100, for controlling a UAV including a plurality of propellers. The method 150 includes a sequence of operations executed to achieve trajectory tracking and stability control of the UAV under external disturbances.

At step 152, the method 150 includes setting an initial rotational speed of each propeller of the plurality of propellers. The initial rotational speed is configured to establish an initial flight state of the UAV before executing control commands.

At step 154, the method 150 includes obtaining a control input including a plurality of desired state trajectories from a user. The control input defines the trajectory that the UAV is intended to follow during flight operations.

At step 156, the method 150 includes determining an altitude-and-attitude control action based on an X-orientation model, wherein the X-orientation model includes an input-to-state feedback linearization, an estimated disturbance, and the control input. The altitude-and-attitude control action comprises a z-direction control, a roll control, a pitch control, and a yaw-axis control. The control input is modified to include a first supertwisting controller and a first sliding surface for disturbance rejection and precise attitude control.

At step 158, the method 150 includes determining a position X-Y control action based on the plurality of desired state trajectories and the X-orientation model with a second supertwisting controller and a second sliding surface. The position X-Y control action guides the UAV to follow the designated path while compensating for disturbances acting in the horizontal plane.

At step 160, the method 150 includes determining a required rotational speed of each propeller of the plurality of propellers based on the altitude-and-attitude control action and the position X-Y control action. The required rotational speed is computed to generate necessary thrust and torque to maintain UAV stability and trajectory tracking.

At step 162, the method 150 includes changing the initial rotational speed of each propeller of the plurality of propellers to the required rotational speed of each propeller of the plurality of propellers to control the UAV. The UAV is then set with the change in rotational speed, and the UAV follows the computed control actions to achieve flight stability and precise trajectory tracking.

FIG. 1C illustrates a quadrotor UAV in an X-configuration, depicting its structural orientation and control parameters. The quadrotor includes four rotors positioned symmetrically about a central body, with two propellers rotating in a clockwise direction and the other two in a counterclockwise direction to maintain stability and achieve controlled motion. The UAV operates within an X-orientation model, where the arms of the quadrotor are aligned diagonally, forming an X-shaped structure.

The UAV is configured to execute altitude-and-attitude control as well as position X-Y control through a dynamic control system that regulates thrust, torque, and rotational speed of the propellers. The X-orientation configuration of the quadrotor follows a fully actuated control model, including a plurality of virtual control inputs to regulate translational and rotational movements across the roll (φ) pitch (θ), yaw (ψ), and vertical (z) axes. The system is further configured to receive a plurality of desired state trajectories, which define target positions and orientations for trajectory tracking.

In the depicted X-configuration, forward motion is achieved by reducing thrust on the rear propellers while increasing thrust on the front propellers, thereby generating a forward pitch. Similarly, lateral movements are achieved by differential thrust adjustments on the left and right propellers. Yaw control is facilitated through counteracting torque variations, achieved by adjusting the relative rotational speeds of clockwise and counterclockwise rotating propellers. Vertical motion is controlled by synchronously increasing or decreasing thrust across all four propellers.

The quadrotor configuration improves maneuverability resulting in stable hovering, precise position tracking, and rapid directional changes. The X-orientation structure renders optimized aerodynamics, reducing drag and improving efficiency in flight operations. The system integrates control algorithms designed to compensate for disturbances and environmental factors, enhancing stability and accuracy in trajectory tracking. The quadrotor UAV is applicable to various aerial missions, including autonomous navigation, aerial surveillance, environmental monitoring, and remote sensing applications.

The mathematical modeling of the quadrotor 170, as illustrated, can be conducted using various techniques, including Newton-Euler and Euler-Lagrange. For position control, the mathematical model of the quadrotor can be expressed as:

$$\ddot{z} = ( cos ϕ cos θ ) \frac{{F}_{z}}{m} - g - {ξ}_{z} \frac{\dot{z}}{m} + {d}_{z} \qquad ( 1 )$$

$$\ddot{ϕ} = \dot{θ} \dot{ψ} \frac{( {I}_{y} - {I}_{z} )}{{I}_{x}} - \frac{{I}_{r}}{{I}_{x}} \dot{θ} \overline{ω} - \frac{{ξ}_{ϕ}}{{I}_{x}} \dot{ϕ} + \frac{1}{{I}_{x}} {τ}_{ϕ} + {d}_{ϕ}$$

$$\ddot{θ} = \dot{ϕ} \dot{ψ} \frac{( {I}_{z} - {I}_{x} )}{{I}_{y}} - \frac{{I}_{r}}{{I}_{y}} \dot{ψ} \overline{ω} - \frac{{ξ}_{θ}}{{I}_{y}} \dot{θ} + \frac{1}{{I}_{y}} {τ}_{θ} + {d}_{θ}$$

$$\ddot{ψ} = \dot{ϕ} \dot{θ} \frac{( {I}_{x} - {I}_{y} )}{{I}_{z}} - \frac{{ξ}_{ψ}}{{I}_{z}} \dot{ψ} + \frac{1}{{I}_{z}} {τ}_{ψ} + {d}_{ψ}$$

$$\ddot{x} = ( cos ϕ sin θ cos ψ + sin ϕ sin ψ ) \frac{{F}_{z}}{m} - {ξ}_{x} \frac{\dot{x}}{m} + {d}_{x}$$

where m denotes the mass of the quadrotor; g is the acceleration due to gravity; Iₓ, I_{y}, I_{z} are the moment of inertia for each axis; ξ_{z}, ξ_{φ}, ξ_{θ} and ξ_{ψ} are the aerodynamic damping coefficients; Iᵣ the inertia of the rotor; ω̅=ω₄+ω₃−ω₂−ω₁ represents the residual rotor angular disturbance; F_{z} the thrust in z direction; τ_{φ}, τ_{θ}, τ_{ψ} the respective input torques in the roll, pitch and yaw axis. The disturbances acting on the system are d_{z}, d_{φ}, d_{θ}, d_{ψ}, dₓ and d_{y}.

Converting the above equation 1 in state-space form yields:

$${\dot{x}}_{1} = {x}_{2} \qquad ( 2 )$$

$${\dot{x}}_{2} = ( cos {x}_{3} cos {x}_{5} ) \frac{{F}_{z}}{m} - g - {ξ}_{z} \frac{{x}_{2}}{m} + {d}_{z}$$

$${\dot{x}}_{3} = {x}_{4}$$

$${\dot{x}}_{4} = {x}_{6} {x}_{8} \frac{( {I}_{y} - {I}_{z} )}{{I}_{x}} - \frac{{I}_{r}}{{I}_{x}} {x}_{6} \overline{ω} - \frac{{ξ}_{ϕ}}{{I}_{x}} {x}_{4} + \frac{1}{{I}_{x}} {τ}_{ϕ} + {d}_{ϕ}$$

$${\dot{x}}_{5} = {x}_{6}$$

$${\dot{x}}_{6} = {x}_{4} {x}_{8} \frac{( {I}_{z} - {I}_{x} )}{{I}_{y}} - \frac{{I}_{r}}{{I}_{y}} {x}_{4} \overline{ω} - \frac{{ξ}_{θ}}{{I}_{y}} {x}_{6} + \frac{1}{{I}_{y}} {τ}_{θ} + {d}_{θ}$$

$${\dot{x}}_{7} = {x}_{8}$$

$${\dot{x}}_{8} = {x}_{4} {x}_{6} \frac{( {I}_{x} - {I}_{y} )}{{I}_{z}} - \frac{{ξ}_{ψ}}{{I}_{z}} {x}_{8} + \frac{1}{{I}_{z}} {τ}_{ψ} + {d}_{ψ}$$

$${\dot{x}}_{9} = {x}_{10}$$

$${\dot{x}}_{10} = - \frac{{ξ}_{x}}{m} {x}_{10} + \frac{{F}_{z} {F}_{x}}{m} + {d}_{x}$$

$${\dot{x}}_{11} = {x}_{12}$$

$${\dot{x}}_{12} = - \frac{{ξ}_{y}}{m} {x}_{12} + \frac{{F}_{z} {F}_{y}}{m} + {d}_{y}$$

As seen from equation 1, the quadrotor is an under-actuated system. To convert it into a fully actuated system, virtual control inputs Fₓ and F_{y} are introduced to control motion in the x, y axis.

The desired roll and pitch angles can then be represented as:

$$\begin{matrix}{ϕ}_{des} = \frac{1}{{F}_{z}} ( {F}_{x} sin {ψ}^{d} - {F}_{y} cos {ψ}^{d} ) \\ {θ}_{des} = \frac{1}{{F}_{z}} ( {F}_{x} cos {ψ}^{d} - {F}_{y} sin {ψ}^{d} )\end{matrix} \} \qquad ( 3 )$$

For a quadrotor in X-configuration the matrix relating the thrust force and torques with the speed of the propeller's can be written as:

$$( \begin{matrix}{F}_{z} \\ {τ}_{ϕ} \\ {τ}_{θ} \\ {τ}_{ψ}\end{matrix} ) = ( \begin{matrix}- {k}_{F} & - {k}_{F} & - {k}_{F} & - {k}_{F} \\ - \frac{1}{\sqrt{2}} {lk}_{F} & - \frac{1}{\sqrt{2}} {lk}_{F} & \frac{1}{\sqrt{2}} {lk}_{F} & \frac{1}{\sqrt{2}} {lk}_{F} \\ \frac{1}{\sqrt{2}} {lk}_{F} & - \frac{1}{\sqrt{2}} {lk}_{F} & - \frac{1}{\sqrt{2}} {lk}_{F} & \frac{1}{\sqrt{2}} {lk}_{F} \\ {k}_{M} & - {k}_{M} & {k}_{M} & - {k}_{M}\end{matrix} ) ( \begin{matrix}{Ω}_{1}^{2} \\ {Ω}_{2}^{2} \\ {Ω}_{3}^{2} \\ {Ω}_{4}^{2}\end{matrix} ) \qquad ( 4 )$$

where k_{F} and k_{M} represents the thrust coefficient, l the length of the arm of the quadrotor.

Rearranging the above equation 4, the required propeller's rotational speed can be represented as:

$$( \begin{matrix}{Ω}_{1} \\ {Ω}_{2} \\ {Ω}_{3} \\ {Ω}_{4}\end{matrix} ) = ( \begin{matrix} & - \frac{1}{4 {k}_{F}} & - \frac{1}{2 \sqrt{2} {lk}_{F}} & \frac{1}{2 \sqrt{2} {lk}_{F}} & \frac{1}{4 {k}_{M}} \\ & - \frac{1}{4 {k}_{F}} & - \frac{1}{2 \sqrt{2} {lk}_{F}} & - \frac{1}{2 \sqrt{2} {lk}_{F}} & - \frac{1}{4 {k}_{M}} \\ & - \frac{1}{4 {k}_{F}} & \frac{1}{2 \sqrt{2} {lk}_{F}} & - \frac{1}{2 \sqrt{2} {lk}_{F}} & \frac{1}{4 {k}_{M}} \\ & - \frac{1}{4 {k}_{F}} & \frac{1}{2 \sqrt{2} {lk}_{F}} & \frac{1}{2 \sqrt{2} {lk}_{F}} & - \frac{1}{4 {k}_{M}}\end{matrix} ) ( \begin{matrix}{F}_{z} \\ {τ}_{ϕ} \\ {τ}_{θ} \\ {τ}_{ψ}\end{matrix} ) \qquad ( 5 )$$

For the purpose of designing the robust control and disturbance observer, the control system is divided into altitude- and attitude control and position X-Y control.

The mathematical model for the altitude-and-attitude control of a quadrotor without considering the disturbances can be written as:

$${\dot{x}}_{1} = {x}_{2} \qquad ( 6 )$$

$${\dot{x}}_{2} = ( cos {x}_{3} cos {x}_{5} ) \frac{{F}_{z}}{m} - g - {ξ}_{z} \frac{{x}_{2}}{m} + {d}_{z}$$

$${\dot{x}}_{3} = {x}_{4}$$

$${\dot{x}}_{4} = {x}_{6} {x}_{8} \frac{( {I}_{y} - {I}_{z} )}{{I}_{x}} - \frac{{I}_{r}}{{I}_{x}} {x}_{6} \overline{ω} - \frac{{ξ}_{ϕ}}{{I}_{x}} {x}_{4} + \frac{1}{{I}_{x}} {τ}_{ϕ} + {d}_{ϕ}$$

$${\dot{x}}_{5} = {x}_{6}$$

$${\dot{x}}_{6} = {x}_{4} {x}_{8} \frac{( {I}_{z} - {I}_{x} )}{{I}_{y}} - \frac{{I}_{r}}{{I}_{y}} {x}_{4} \overline{ω} - \frac{{ξ}_{θ}}{{I}_{y}} {x}_{6} + \frac{1}{{I}_{y}} {τ}_{θ} + {d}_{θ}$$

$${\dot{x}}_{7} = {x}_{8}$$

$${\dot{x}}_{8} = {x}_{4} {x}_{6} \frac{( {I}_{x} - {I}_{y} )}{{I}_{z}} - \frac{{ξ}_{ψ}}{{I}_{z}} {x}_{8} + \frac{1}{{I}_{z}} {τ}_{ψ} + {d}_{ψ}$$

representing the above equation 6 in the form \dot{x}=f(x)+g(x)u+d, where f(x), g(x), u and d can be written as:

$$f ( x ) = [ \begin{matrix}{x}_{2} \\ - g - {ξ}_{z} \frac{{x}_{2}}{m} \\ {x}_{4} \\ {x}_{6} {x}_{8} \frac{( {I}_{y} - {I}_{z} )}{{I}_{x}} - \frac{{I}_{r}}{{I}_{x}} {x}_{6} \overline{ω} - \frac{{ξ}_{ϕ}}{{I}_{x}} {x}_{4} \\ {x}_{6} \\ {x}_{4} {x}_{8} \frac{( {I}_{z} - {I}_{x} )}{{I}_{y}} - \frac{{I}_{r}}{{I}_{y}} {x}_{4} \overline{ω} - \frac{{ξ}_{θ}}{{I}_{y}} {x}_{6} \\ {x}_{8} \\ {x}_{4} {x}_{6} \frac{( {I}_{x} - {I}_{y} )}{{I}_{z}} - \frac{{ξ}_{ψ}}{{I}_{z}} {x}_{8}\end{matrix} ] \qquad ( 7 )$$

$$g ( x ) = [ \begin{matrix}0 & 0 & 0 & 0 \\ \frac{cos {x}_{3} cos {x}_{5}}{m} & 0 & 0 & 0 \\ 0 & 0 & 0 & 0 \\ 0 & \frac{1}{{I}_{x}} & 0 & 0 \\ 0 & 0 & & 0 \\ 0 & 0 & \frac{1}{{I}_{y}} & 0 \\ 0 & 0 & 0 & 0 \\ 0 & 0 & 0 & \frac{1}{{I}_{z}}\end{matrix} ] \qquad ( 8 )$$

$$u = [ \begin{matrix}{F}_{z} \\ {τ}_{ϕ} \\ {τ}_{θ} \\ {τ}_{ψ}\end{matrix} ] \qquad ( 9 )$$

$$d = [ \begin{matrix}0 \\ {d}_{z} \\ 0 \\ {d}_{ϕ} \\ 0 \\ {d}_{θ} \\ 0 \\ {d}_{ψ}\end{matrix} ] \qquad ( 10 )$$

In order to implement input-to-state feedback linearization, the control action can be calculated as:

$$[ \begin{matrix}{F}_{z} \\ {τ}_{ϕ} \\ {τ}_{θ} \\ {τ}_{ψ}\end{matrix} ] = [ \begin{matrix}\frac{m}{cos {x}_{3} cos {x}_{5}} ( g + {ξ}_{z} \frac{{x}_{2}}{m} + {v}_{1} - {\hat{d}}_{z} ) \\ {I}_{x} ( - {x}_{6} {x}_{8} \frac{( {I}_{y} - {I}_{z} )}{{I}_{x}} + \frac{{I}_{r}}{{I}_{x}} {x}_{6} \overline{ω} + \frac{{ξ}_{ϕ}}{{I}_{x}} {x}_{4} + {v}_{2} - {\hat{d}}_{ϕ} ) \\ {I}_{y} ( - {x}_{4} {x}_{8} \frac{( {I}_{z} - {I}_{x} )}{{I}_{y}} + \frac{{I}_{r}}{{I}_{y}} {x}_{4} \overline{ω} + \frac{{ξ}_{θ}}{{I}_{y}} {x}_{6} + {v}_{3} - {\hat{d}}_{θ} ) \\ {I}_{z} ( - {x}_{4} {x}_{6} \frac{( {I}_{x} - {I}_{y} )}{{I}_{z}} + \frac{{ξ}_{ψ}}{{I}_{z}} {x}_{8} + {v}_{4} - {\hat{d}}_{ψ} )\end{matrix} ] \qquad ( 11 )$$

where \hat{d}_{z}, \hat{d}_{φ}, \hat{d}_{θ} and \hat{d}_{ψ} are the estimated disturbances. Considering tracking problem, the inputs a proportional derivative controller can be designed as v₁, v₂, v₃ and v₄, which are the control inputs to the feedback linearized plant:

$$\begin{matrix}{v}_{1} = {\dot{x}}_{2}^{d} - {K}_{pz} {e}_{1} - {K}_{dz} {e}_{2} \\ {v}_{2} = {\dot{x}}_{4}^{d} - {K}_{p ϕ} {e}_{3} - {K}_{d ϕ} {e}_{4} \\ {v}_{3} = {\dot{x}}_{6}^{d} - {K}_{p θ} {e}_{5} - {K}_{d θ} {e}_{6} \\ {v}_{4} = {\dot{x}}_{8}^{d} - {K}_{p ψ} {e}_{7} - {K}_{d ψ} {e}_{8}\end{matrix} \} \qquad ( 12 )$$

where

$${e}_{i} = {x}_{i} - {x}_{i}^{d} ,$$

where i=1, . . . , 8 and

$${x}_{i}^{d}$$

is the desired state trajectory.

The first supertwisting controller and the second supertwisting controller are represented by:

$$- {k}_{1 j} {\vert {s}_{j} \vert}^{0.5} sgn ( {s}_{j} ) - {k}_{2 j \int sgn ( {s}_{j} )} ,$$

wherein the k₁ⱼ and the k₂ⱼ are gains of the supertwisting controller for an axis j, wherein the axis j is selected from the group consisting of a z-direction axis, a roll axis, a pitch axis, and a yaw axis, and wherein the sⱼ is a sliding surface of the axis j;

wherein the sⱼ is represented by cⱼe₂ᵢ₋₁+e₂ᵢ, wherein the cᵢ is a design constant of the axis j, wherein the

$${e}_{i} = {x}_{i} - {x}_{i}^{d} ,$$

wherein the xᵢ is the current position of axis j, wherein the

$${x}_{i}^{d}$$

is a plurality of desired state trajectories of axis j, and wherein i=1 when the axis j is the z-direction axis, i=2 when the axis j is the roll axis, i=3 when the axis j is the pitch axis, i=4 when the axis j is the yaw axis.

In-order to add robustness to the existing controller, a supertwisting controller will be added in the outerloop of the feedback linearized controller. Addition of the supertwisting control action modifies the control inputs v₁, v₂, v₃ and v₄ as:

$$\begin{matrix}{v}_{1 , new} = {\dot{x}}_{2}^{d} - {K}_{pz} {e}_{1} - {K}_{dz} {e}_{2} - {k}_{1 z} {\vert {s}_{z} \vert}^{0.5} sign ( {s}_{z} ) \\ - {k}_{2 z} \int sign ( {s}_{z} ) dt\end{matrix} \qquad ( 13 )$$

$$\begin{matrix}{v}_{2 , new} = {\dot{x}}_{4}^{d} - {K}_{p ϕ} {e}_{5} - {K}_{d ϕ} {e}_{4} - {k}_{1 ϕ} {\vert {s}_{ϕ} \vert}^{0.5} sign ( {s}_{ϕ} ) \\ - {k}_{2 ϕ} \int sign ( {s}_{ϕ} ) dt\end{matrix}$$

$$\begin{matrix}{v}_{3 , new} = {\dot{x}}_{6}^{d} - {K}_{p θ} {e}_{5} - {K}_{d θ} {e}_{6} - {k}_{1 θ} {\vert {s}_{θ} \vert}^{0.5} sign ( {s}_{θ} ) \\ - {k}_{2 θ} \int sign ( {s}_{θ} ) dt \\ - {k}_{2 ψ} \int sign ( {s}_{ψ} ) dt\end{matrix}$$

where k₁ and k₂ are the gains of the supertwisting controller for the z-direction, roll, pitch and yaw-axis. The sliding surface for the supertwisting controller can be represented as:

$$\begin{matrix}{s}_{z} = {c}_{1} {e}_{1} + {e}_{2} \\ {s}_{ϕ} = {c}_{2} {e}_{3} + {e}_{4} \\ {s}_{θ} = {c}_{3} {e}_{5} + {e}_{6} \\ {s}_{ψ} = {c}_{4} {e}_{7} + {e}_{8}\end{matrix} \} \qquad ( 14 )$$

where c₁, c₂, c₃, c₄ are the design constants.

Once the altitude-and-attitude controller is designed, stability analysis of altitude-and-attitude controller is performed.

For analyzing the stability of the feedback linearization based controller part, the system can be written in the following standard form, ė=A_{cl}e, where A_{cl} is the closed loop error dynamics matrix represented as:

$${A}_{cl} = [ \begin{matrix}0 & 1 & 0 & 0 & 0 & 0 & 0 & 0 \\ - {K}_{pz} & - {K}_{dz} & 0 & 0 & 0 & 0 & 0 & 0 \\ 0 & 0 & 0 & 1 & 0 & 0 & 0 & 0 \\ 0 & 0 & - {K}_{p ϕ} & - {K}_{d ϕ} & 0 & 0 & 0 & 0 \\ 0 & 0 & 0 & 0 & 0 & 1 & 0 & 0 \\ 0 & 0 & 0 & 0 & - {K}_{p θ} & - {K}_{d θ} & 0 & 0 \\ 0 & 0 & 0 & 0 & 0 & 0 & 0 & 1 \\ 0 & 0 & 0 & 0 & 0 & 0 & - {K}_{p ψ} & - {K}_{d ψ}\end{matrix} ] \qquad ( 15 )$$

The stability of the closed-loop system is ensured by selecting values of Kₚ, K_{d}>0, which yields eig|A_{cl}|<0. This ensures that the errors eᵢ→0 as t→∞, where i=1, . . . , 8.

As for the supertwisting controller, the stability can be derived as:

$$\begin{matrix}{\dot{z}}_{1} = - {k}_{1} {\vert {z}_{1} \vert}^{0.5} sign ( {z}_{1} ) + {z}_{2} \\ {\dot{z}}_{2} = - {k}_{2} sign ( {z}_{2} ) + ρ\end{matrix} \} \qquad ( 16 )$$

where z₁, z₂∈ [symbol] and the disturbance p is bounded by |z₁|<δ.

Consider a Lyapunov function which can be written in quadratic form as V₁=ζ^{T}Pζ where ζ^{T}=[|z₁|^{0.5}sign(z₁)z₂] and P is positive definite matrix. V₁ is continuously differentiable except for when z₁=0. \dot{V}₁ exists and is negative differentiable ∀z₁≠0.

The Lyapunov function V₁ is both positive definite and radially unbounded:

$${λ}_{min} ( P ) {‖ ζ ‖}^{2} \leq {V}_{1} \leq {λ}_{max} ( P ) {‖ ζ ‖}^{2} \qquad ( 17 )$$

The Euclidean norm of ζ can be written as

$${‖ ζ ‖}^{2} = \vert {z}_{1} \vert + {z}_{2}^{2} .$$

Ine following algebraic equation can be constructed:

$$( \begin{matrix}{A}^{T} P + PA + ϵ P + {δ}^{2} {C}^{T} C & PB \\ {B}^{T} P & - 1\end{matrix} ) < 0 \qquad ( 18 )$$

where

$$A = [ \begin{matrix}- \frac{1}{2} {k}_{1} & \frac{1}{2} \\ - {k}_{2} & 0\end{matrix} ] ; B = [ \begin{matrix}0 \\ 1\end{matrix} ] and C = [ \begin{matrix}0 & 1\end{matrix} ] ,$$

with k₁, k₂>0. Using ζ^{T}=[|z₁|^{0.5} sign(z₁)z₂], equation 16 can be written as:

$${\dot{ζ}}_{1} = \frac{1}{\vert {ζ}_{1} \vert} ( A ζ + B \tilde{ρ} ) \qquad ( 19 )$$

Using the assumption that the perturbation is uniformly bounded satisfying 2|p|≤δ, the transformed perturbation \tilde{ρ}=|ζ₁|ρ satisfies |\tilde{ρ}|≤δ|ζ₁|. This results in

$$\hat{ω} = - {\tilde{ρ}}^{2} + {δ}^{2} {ζ}_{1}^{2} \geq 0.$$

Considering the Lyapunov equation V₁=ζ^{T}Pζ, its derivative becomes:

$$\dot{V} = {\frac{1}{\vert {ζ}_{1} \vert} [ \begin{matrix}ζ & \tilde{ρ}\end{matrix} ]}^{T} [ \begin{matrix}{A}^{T} P + PA & PB \\ {B}^{T} P & - 1\end{matrix} ] [ \begin{matrix}ζ & \tilde{ρ}\end{matrix} ] \leq \frac{1}{\vert {ζ}_{1} \vert} \{ {[ \begin{matrix}ζ & \tilde{ρ}\end{matrix} ]}^{T} [ \begin{matrix}{A}^{T} P + PA & PB \\ {B}^{T} P & - 1\end{matrix} ] [ \begin{matrix}ζ & \tilde{ρ}\end{matrix} ] + \hat{ω} \} ] \leq \frac{1}{\vert {ζ}_{1} \vert} \{ {[ \begin{matrix}ζ & \tilde{ρ}\end{matrix} ]}^{T} [ \begin{matrix}{A}^{T} P + PA + {δ}^{2} {C}^{T} C & PB \\ {B}^{T} P & - 1\end{matrix} ] [ \begin{matrix}ζ & \tilde{ρ}\end{matrix} ] \leq \frac{1}{\vert {ζ}_{1} \vert} \{ {[ \begin{matrix}ζ & \tilde{ρ}\end{matrix} ]}^{T} [ \begin{matrix}{A}^{T} P + PA + ϵ P - ϵ P + {δ}^{2} {C}^{T} C & PB \\ & {B}^{T} P\end{matrix} ] [ ζ \tilde{ρ} ] \leq - \frac{ϵ}{\vert {ζ}_{1} \vert} {ζ}^{T} P ζ \qquad ( 20 )$$

Therefore

$${\dot{V}}_{1} \leq - \frac{ϵ}{\vert {ζ}_{1} \vert} {ζ}^{T} P ζ = - \frac{ϵ}{\vert {ζ}_{1} \vert} {V}_{1} .$$

From the equation 17 the following inequality can be deduced:

$$\vert {ζ}_{1} \vert \leq ‖ ζ ‖ \leq \frac{{V}_{1}^{0.5}}{{λ}_{min ( P )}}$$

This concludes that \dot{V}₁ satisfies

$${\dot{V}}_{1} \leq - {αV}_{1}^{0.5} ,$$

where

$$α = {ϵλ}_{min}^{0.5} P .$$

This guarantees finite time convergence where time is bounded by

$${T}_{s} = \frac{2 {V}_{1}^{0.5} ζ ( 0 )}{α} ,$$

where ζ(0) is the initial value of ζ. For the LMI equation in equation 18 to be satisfied, the transfer function G(s)=C(sl−A)⁻¹B has to satisfy the following max|G(jω)|<1. This implies that

$$max \vert G ( j ω ) \vert < \frac{1}{δ} .$$

Using this inequality the following conditions on the gains can be achieved if

$$max \vert G ( j ω ) \vert < \frac{1}{k}$$

if

$${k}_{1}^{2} > {k}_{2} .$$

Then the conditions on k₁ and

$${{k}_{2}}^{ω}$$

can be deduced as: k₂>δ and

$${k}_{1}^{2} > 4 {k}_{2} .$$

After stability analysis of the altitude-and-attitude controller, the position XY Controller is analyzed.

The remaining part of the quadrotor dynamics can be represented as:

$$\begin{matrix}{\dot{x}}_{9} = {x}_{10} \\ {\dot{x}}_{10} = - \frac{{ξ}_{x}}{m} {x}_{10} + \frac{{F}_{z} {F}_{x}}{m} + {d}_{x} \\ {\dot{x}}_{11} = {x}_{12} \\ {\dot{x}}_{12} = - \frac{{ξ}_{y}}{m} {x}_{12} + \frac{{F}_{z} {F}_{y}}{m} + {d}_{y}\end{matrix} \} \qquad ( 21 )$$

The control action similar to the fully actuated system can be designed as:

$$\begin{matrix}\begin{matrix}{F}_{x} = \frac{m}{{F}_{z}} ( {\dot{x}}_{10}^{d} + \frac{{ξ}_{x}}{m} {x}_{10} - {K}_{px} {e}_{9} - {K}_{dx} {e}_{10} \\ - {k}_{1 x} {\vert {s}_{x} \vert}^{0.5} sign ( {s}_{x} ) - {k}_{2 x} \int sign ( {s}_{x} ) - {\hat{d}}_{x} ) \\ {F}_{y} = \frac{m}{{F}_{z}} ( {\dot{x}}_{12}^{d} + \frac{{ξ}_{y}}{m} {x}_{12} - {K}_{py} {e}_{11} - {K}_{dy} {e}_{12} \\ - {k}_{1 y} {\vert {s}_{y} \vert}^{0.5} sign ( {s}_{y} ) - {k}_{2 y} \int sign ( {s}_{y} ) - {\hat{d}}_{y} )\end{matrix} & \}\end{matrix} \qquad ( 22 )$$

where Kₚ, K_{d}>0 and k₁, k₂ are the controller design gains of the supertwisting controller,

$${e}_{i} = {x}_{i} - {x}_{i}^{d} ,$$

where i=9, . . . , 12 and xᵢ^{d} is the desired state trajectory. The sliding surfaces are chosen as:

$$\begin{matrix}{s}_{x} = {c}_{5} {e}_{9} + {e}_{10} \\ {s}_{y} = {c}_{6} {e}_{11} + {e}_{12}\end{matrix} \} \qquad ( 23 )$$

where c₅, c₆ are design constants of the sliding surface. The stability analysis for the X-Y position control can be performed similarly to the altitude-and-attitude control stability analysis: by analyzing the proportional derivative controller and supertwisting controller separately assuming the thrust, F_{z}, to be bounded.

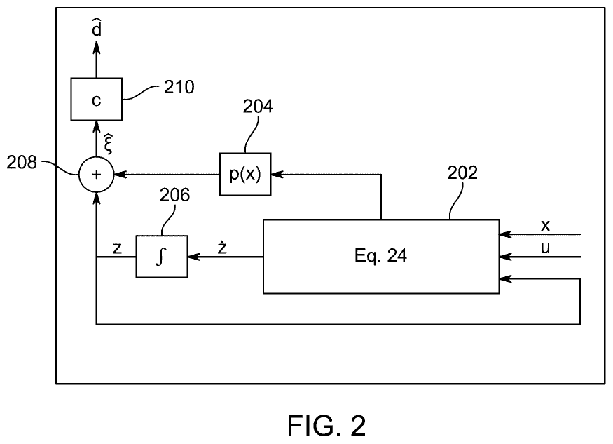

FIG. 2 illustrates a block diagram of a NHDO configured to estimate and compensate for external disturbances acting on a quadrotor UAV. The NHDO includes an equation computation unit 202, a function processing unit 204, an integration unit 206, a summation node 208, and a correction unit 210. The equation computation unit 202 receives state variables and control inputs x and u and executes a predefined dynamic model, represented by equation 24, to estimate the internal system dynamics. The function processing unit 204 applies a function p(x) to the estimated state to derive a transformed disturbance representation. The integration unit 206 accumulates the estimated values over time to refine the disturbance approximation. The summation node 208 computes an error term based on the estimated and actual system responses, generating an error signal ξ that quantifies the deviation due to external disturbances. The correction unit 210 applies a correction gain c to the error signal ξ to generate an acceleration output â, which compensates for the estimated disturbances and improves the system's robustness to dynamic environmental conditions. The harmonic nonlinear disturbance observer, by continuously adapting the disturbance estimate, enhances the quadrotor UAV's ability to maintain stable flight trajectories under varying external perturbations, such as wind gusts and load variations.

The enhanced formulation of the harmonic disturbance observer 200 is described as:

$$\dot{z} = [ A - l ( x ) {g}_{2} ( x ) C ] z + Ap ( x ) - l ( x ) [ {g}_{2} ( x ) Cp ( x ) + f ( x ) + {g}_{1} ( x ) u ] \qquad ( 24 )$$

$$\begin{matrix}\hat{ξ} = z + p ( x ) \\ \hat{d} = C \hat{ξ} \\ l ( x ) = \frac{\partial p ( x )}{\partial x}\end{matrix} \} \qquad ( 25 )$$

$$\dot{x} = f ( x ) + {g}_{1} ( x ) u + {g}_{2} ( x ) d \qquad ( 26 )$$

The error dynamics of the disturbance and its estimation is represented as:

$${e}_{ξ} = \hat{ξ} - ξ \qquad ( 27 )$$

$$\begin{matrix}{\dot{e}}_{ξ} = \dot{\hat{ξ}} - \dot{ξ} \\ \dot{z} + \frac{\partial p ( x )}{\partial x} \dot{x} - A ξ \\ [ A - l ( x ) {g}_{2} ( x ) C ] z + Ap ( x ) \\ - l ( x ) [ {g}_{2} ( x ) Cp ( x ) + f ( x ) + {g}_{1} ( x ) u ] \\ = [ A - l ( x ) {g}_{2} ( x ) C ] ( \hat{ξ} - p ( x ) ) + Ap ( x ) \\ - l ( x ) [ {g}_{2} ( x ) Cp ( x ) + f ( x ) + {g}_{1} ( x ) u ] \\ + l ( x ) [ f ( x ) + {g}_{1} ( x ) u + {g}_{2} ( x ) C ξ ] - A ξ \\ = [ A - l ( x ) {g}_{2} ( x ) C ] ( \hat{ξ} - ξ ) \\ = [ A - l ( x ) {g}_{2} ( x ) C ] {e}_{ξ}\end{matrix}$$

From equation 27 if l(x) is selected such that \hat{ξ} approaches ξ exponentially and ė_{ξ} is globally exponentially stable.

The control action after the addition of estimated disturbance for the Altitude and Attitude system can be written as:

$${v}_{1 , new} = {\dot{x}}_{2}^{d} - {K}_{pz} {e}_{1} - {K}_{dz} {e}_{2} - {k}_{1 z} {\vert {s}_{z} \vert}^{0.5} sign ( {s}_{z} ) - {k}_{2 z} \int sign ( {s}_{z} ) dt - {\hat{d}}_{z} \qquad ( 28 )$$

$${v}_{2 , new} = {\dot{x}}_{4}^{d} - {K}_{p ϕ} {e}_{3} - {K}_{d ϕ} {e}_{4} - {k}_{1 ϕ} {\vert {s}_{ϕ} \vert}^{0.5} sign ( {s}_{ϕ} ) - {k}_{2 ϕ} \int sign ( {s}_{ϕ} ) dt - {\hat{d}}_{ϕ}$$

$${v}_{3 , new} = {\dot{x}}_{6}^{d} - {K}_{p θ} {e}_{5} - {K}_{d θ} {e}_{6} - {k}_{1 θ} {\vert {s}_{θ} \vert}^{0.5} sign ( {s}_{θ} ) - {k}_{2 θ} \int sign ( {s}_{θ} ) dt - {\hat{d}}_{θ}$$

$${v}_{4 , new} = {\dot{x}}_{8}^{d} - {K}_{p ψ} {e}_{7} - {K}_{d ψ} {e}_{8} - {k}_{1 ψ} {\vert {s}_{ψ} \vert}^{0.5} sign ( s ψ ) - {k}_{2 ψ} \int sign ( {s}_{ψ} ) - {\hat{d}}_{ψ}$$

while for the position X-Y system can be written as:

$$\begin{matrix}{F}_{x} = \frac{m}{{F}_{z}} ( {\dot{x}}_{10}^{d} + \frac{{ξ}_{x}}{m} {x}_{10} - {K}_{px} {e}_{9} - {K}_{dx} {e}_{10} \\ - {k}_{1 x} {\vert {s}_{x} \vert}^{0.5} sign ( {s}_{x} ) - {k}_{2 x} \int sign ( {s}_{x} ) dt - {\hat{d}}_{x} ) \\ {F}_{y} = \frac{m}{{F}_{z}} ( {\dot{x}}_{12}^{d} + \frac{{ξ}_{y}}{m} {x}_{12} - {K}_{py} {e}_{11} - {K}_{dy} {e}_{12} \\ - {k}_{1 y} {\vert {s}_{y} \vert}^{0.5} sign ( {s}_{y} ) - {k}_{2 y} \int sign ( {s}_{y} ) dt - {\hat{d}}_{y} )\end{matrix} \} \qquad ( 29 )$$

The ISMC defers from the regular sliding mode controller by designing its sliding surface which includes the integral terms of all the errors.

Modeling of the controller design for ISMC is developed as below.

For tracking of desired states, the sliding surface for the roll axis is defined as:

$${s}_{ϕ} = {c}_{{1}_{ϕ}} {e}_{{1}_{ϕ}} + {e}_{{2}_{ϕ}} + {c}_{{2}_{ϕ}} {e}_{{3}_{ϕ}} + {e}_{{4}_{ϕ}} \qquad ( 30 )$$

$${e}_{{1}_{ϕ}} = {x}_{3} - {x}_{3}^{d}$$

$${e}_{{2}_{ϕ}} = {x}_{4} - {x}_{4}^{d}$$

$${e}_{{3}_{ϕ}} = \int ( {x}_{3} - {x}_{3}^{d} ) dt$$

$${e}_{{4}_{ϕ}} = \int ( {x}_{4} - {x}_{4}^{d} ) dt$$

The derivative of the sliding surface can be defined as:

$${s}_{ϕ} = {c}_{{1}_{ϕ}} {e}_{1 ϕ} + {e}_{2 ϕ} + {c}_{{2}_{ϕ}} {e}_{{1}_{ϕ}} + {e}_{{2}_{ϕ}} \qquad ( 31 )$$

Inserting the time derivatives of the errors in equation 31 yields:

$${s}_{ϕ} = {c}_{{1}_{ϕ}} ( {\dot{x}}_{3} - {\dot{x}}_{3}^{d} ) + {\dot{x}}_{4} - {\dot{x}}_{4}^{d} + {c}_{{2}_{ϕ}} {e}_{{1}_{ϕ}} + {e}_{{2}_{ϕ}} \qquad ( 32 )$$

In order to make the Lyapunov function negative-definite, equate \dot{s}_{φ}=−k|s_{φ}|^{0.5}sign(s_{φ}).

The control action for the roll-axis then yields:

$${τ}_{ϕ} = - {I}_{x} ( {\dot{x}}_{4}^{d} + {x}_{6} {x}_{8} \frac{( {I}_{y} - {I}_{z} )}{{I}_{x}} - \frac{{I}_{r}}{{I}_{x}} {x}_{6} \overline{ω} - \frac{{ξ}_{ϕ}}{{I}_{x}} {x}_{4} + {k}_{ϕ} {\vert {s}_{ϕ} \vert}^{0.5} sign ( {s}_{ϕ} ) + {c}_{{1}_{ϕ}} {e}_{{2}_{ϕ}} + {c}_{{2}_{ϕ}} {e}_{{1}_{ϕ}} + {e}_{{2}_{ϕ}} - {\hat{d}}_{ϕ} ) ) \qquad ( 33 )$$

where k_{φ} is the gain of the integral sliding mode and \hat{d}_{φ} is the estimated disturbance in the roll-axis.

The ISMC for the x-axis can be designed as:

$${F}_{x} = \frac{m}{{F}_{z}} ( - \frac{{ξ}_{x}}{m} {x}_{10} - {k}_{x} {\vert {s}_{x} \vert}^{0.5} sign ( {s}_{x} ) - {c}_{1 x} {e}_{2 x} - {c}_{2 x} {e}_{1 x} - {e}_{2 x} - {\hat{d}}_{x} ) \qquad ( 34 )$$

where kₓ is the gain of the integral sliding mode and \hat{d}ₓ is the estimated disturbance in the x-axis.

The sliding surface is chosen as sₓ=c₁ₓe₁_{ₓ}+e₂_{ₓ}+c₂ₓe₃_{ₓ}+e₄_{ₓ}, where c₁ₓ and c₂ₓ are the design parameter. The errors e₁_{ₓ}=x₉−x_{9d}, e₂_{ₓ}=x₁₀−x_{10d}, e₃_{ₓ}=∫ e₁_{ₓ}dt and e₄_{ₓ}=∫ e₂_{ₓ}dt.

The ISMC patched with harmonic disturbance observer for the complete quadrotor system for tracking of states is defined as:

$$\begin{matrix}{F}_{z} & = \frac{m}{cos {x}_{3} cos {x}_{5}} ( {\dot{x}}_{2}^{d} + g + {ξ}_{z} \frac{{x}_{2}}{m} - {k}_{z} {\vert {s}_{z} \vert}^{0.5} sign ( {s}_{z} ) - {c}_{1 z} {x}_{2} - {c}_{2 z} {e}_{1 z} - {e}_{2 z} - {\hat{d}}_{z} ) \\ {τ}_{ϕ} & = {I}_{x} ( {\dot{x}}_{4}^{d} - {x}_{6} {x}_{8} \frac{( {I}_{y} - {I}_{z} )}{{I}_{x}} + \frac{{I}_{y}}{{I}_{x}} {x}_{6} \overline{ω} + \frac{{ξ}_{ϕ}}{{I}_{x}} {x}_{4} - {k}_{ϕ} {\vert {s}_{ϕ} \vert}^{0.5} sign ( {s}_{ϕ} ) - {c}_{1 ϕ} {e}_{2 ϕ} - {c}_{2 ϕ} {e}_{1 ϕ} - {e}_{2 ϕ} - {\hat{d}}_{ϕ} ) \\ {τ}_{θ} & = {I}_{y} ( {\dot{x}}_{6}^{d} - {x}_{4} {x}_{8} \frac{( {I}_{z} - {I}_{x} )}{{I}_{y}} + \frac{{I}_{y}}{{I}_{y}} {x}_{4} \overline{ω} + \frac{{ξ}_{θ}}{{I}_{y}} {x}_{6} - {k}_{θ} {\vert {s}_{θ} \vert}^{0.5} sign ( {s}_{θ} ) - {c}_{1 θ} {e}_{2 θ} - {c}_{2 θ} {e}_{1 θ} - {e}_{2 θ} - {\hat{d}}_{θ} ) \\ {τ}_{ψ} & = {I}_{z} ( {\dot{x}}_{8}^{d} - {x}_{4} {x}_{6} \frac{( {I}_{x} - {I}_{y} )}{{I}_{z}} + \frac{{ξ}_{ψ}}{{I}_{z}} {x}_{8} - {k}_{ψ} {\vert {s}_{ψ} \vert}^{0.5} sign ( {s}_{ψ} ) - {c}_{1 ψ} {e}_{2 ψ} - {c}_{2 ψ} {e}_{1 ψ} - {e}_{2 ψ} - {\hat{d}}_{ψ} )\end{matrix} \} \qquad ( 35 )$$

while the control action for x and y axis can be defined as:

$$\begin{matrix}{F}_{x} & = \frac{m}{{F}_{z}} ( {\dot{x}}_{10}^{d} - \frac{{ξ}_{x}}{m} {x}_{10} - {k}_{x} {\vert {s}_{x} \vert}^{0.5} sign ( {s}_{x} ) - {c}_{1 x} {e}_{2 x} - {c}_{2 x} {e}_{1 x} - {e}_{2 x} - {\hat{d}}_{x} ) \\ {F}_{y} & = \frac{m}{{F}_{z}} ( {\dot{x}}_{12}^{d} - \frac{{ξ}_{y}}{m} {x}_{12} - {k}_{y} {\vert {s}_{y} \vert}^{0.5} sign ( {s}_{y} ) - {c}_{1 y} {e}_{2 y} - {c}_{2 y} {e}_{1 y} - {e}_{2 y} - {\hat{d}}_{y} )\end{matrix} \} \qquad ( 36 )$$

Stability of the UAV is determined using a Lyapunov analysis. Therefore, the Lyapunov function is used to perform the stability analysis of harmonic the nonlinear disturbance observer 200.

Considering the Lyapunov candidate function as:

$$V = \frac{1}{2} {s}^{2} \qquad ( 37 )$$

Taking its derivative, \dot{V}=s\dot{s} is achieved. Inserting \dot{s}=−k|s|^{0.5}sign(s), \dot{V}=s(−k|s|^{0.5}sign(s)) is obtained.

For simplification, sign(s) can also be written as sign

$$( s ) = \frac{\vert s \vert}{s} .$$

Substituting this in \dot{V} gives:

$$\dot{V} = - k {\vert s \vert}^{1.5} \qquad ( 38 )$$

Since k is a positive number, \dot{V} will always be negative definite, which ensures asymptotic stability.

Mathematical modeling of the TSC is performed. Synergetic control achieves convergence of state variables as time goes to infinity. To achieve finite time convergence TSC is used which combines synergetic control theory with terminal attractor to achieve finite time convergence.

A controller for the roll-axis is developed, similarly controllers for the remaining axis can also be designed. It can be started by introducing a macro-variable ζ, which is expressed as:

$$ζ = {e}_{1 ϕ} + {{w}_{1 ϕ} ( {\int }_{0}^{t} {e}_{1 ϕ} dt )}^{{p}_{1} / {q}_{1}} + {e}_{2 ϕ} + {{w}_{2 ϕ} ( {\int }_{0}^{t} {e}_{2 ϕ} dt )}^{{p}_{2} / {q}_{2}} \qquad ( 39 )$$

where w_{1φ} and w_{2φ} are positive constants chosen by the designer, while p₁, q₁, p₂ and q₂are odd positive numbers such that

$$1 < \frac{{p}_{1}}{{q}_{1}} < 2 and 1 < \frac{{p}_{2}}{{q}_{2}} < 2 .$$

The errors are defined as

$${e}_{1 ϕ} = {x}_{3} - {x}_{3}^{d} and {e}_{2 ϕ} = {x}_{4} - {x}_{4}^{d} .$$

Taking the time derivative of ζ:

$$\dot{ζ} = {e}_{1 ϕ} + {w}_{1 ϕ} ( \frac{{p}_{1}}{{q}_{1}} ) {{e}_{1 ϕ} ( {\int }_{0}^{t} {e}_{1 ϕ} dt )}^{{p}_{1} / {q}_{1} - 1} + {e}_{2 ϕ}^{\cdot } \qquad ( 40 )$$

After placing the values of ė₁ and ē₂:

$$\dot{ζ} = {x}_{4} + {w}_{1 ϕ} ( \frac{{p}_{1}}{{q}_{1}} ) {{e}_{1 ϕ} ( {\int }_{0}^{t} {e}_{1 ϕ} dt )}^{{p}_{1} / {q}_{1} - 1} + {x}_{6} {x}_{8} \frac{( {I}_{y} - {I}_{z} )}{{I}_{x}} - \frac{{I}_{r}}{{I}_{x}} {x}_{6} \overline{ω} - \frac{{ξ}_{ϕ}}{{I}_{x}} {x}_{4} + \frac{1}{{I}_{x}} {τ}_{ϕ} - {\dot{x}}_{4}^{d} \qquad ( 41 )$$

Considering the following relation between ζ and \dot{ζ}:

$${T}_{ϕ} \dot{ζ} + ζ = 0 \qquad ( 42 )$$

where T_{φ} is a positive constant and is the convergence rate of the terminal attractor.

By putting equation 41 in equation 42:

$${T}_{ϕ} ( {x}_{4} + {w}_{1 ϕ} ( \frac{{p}_{1}}{{q}_{1}} ) {{e}_{1 ϕ} ( {\int }_{0}^{t} {e}_{1 ϕ} dt )}^{{p}_{1} / {q}_{1} - 1} + {x}_{6} {x}_{8} \frac{( {I}_{y} - {I}_{z} )}{{I}_{x}} - \frac{{I}_{r}}{{I}_{x}} {x}_{6} \overline{ω} - \frac{{ξ}_{ϕ}}{{I}_{x}} {x}_{4} + \frac{1}{{I}_{x}} {τ}_{ϕ} - {\dot{x}}_{4}^{d} + {w}_{2 ϕ} ( \frac{{p}_{2}}{{q}_{2}} ) {{e}_{2 ϕ} ( {\int }_{0}^{t} {e}_{2 ϕ} dt )}^{{p}_{2} / {q}_{2} - 1} ) + ζ = 0 ) \qquad ( 43 )$$

Solving equation 43 for the control input τ_{φ}:

$${τ}_{ϕ} = {I}_{x} ( {\dot{x}}_{4}^{d} - {x}_{6} {x}_{8} \frac{( {I}_{y} - {I}_{z} )}{{I}_{x}} + \frac{{I}_{r}}{{I}_{x}} {x}_{6} \overline{ω} + \frac{{ξ}_{ϕ}}{{I}_{x}} {x}_{4} - \frac{{ζ}_{ϕ}}{{T}_{ϕ}} - {x}_{4} - {w}_{1 ϕ} ( \frac{{p}_{1}}{{q}_{1}} ) {{e}_{1 ϕ} ( {\int }_{0}^{t} {e}_{1 ϕ} dt )}^{{p}_{1} / {q}_{1} - 1} - {w}_{2 ϕ} ( \frac{{p}_{2}}{{q}_{2}} ) {{e}_{2 ϕ} ( {\int }_{0}^{t} {e}_{2 ϕ} dt )}^{{p}_{2} / {q}_{2} - 1} ) \qquad ( 44 )$$

The TSC for the x-axis position control is as follows:

$${F}_{x} = \frac{m}{{F}_{z}} ( {\dot{x}}_{10}^{d} - \frac{{ζ}_{x}}{{T}_{x}} - {x}_{10} - {w}_{1 x} ( \frac{{p}_{1}}{{q}_{1}} ) {{e}_{1 x} ( {\int }_{0}^{t} {e}_{1 x} dt )}^{{p}_{1} / {q}_{1} - 1} - {w}_{2 x} ( \frac{{p}_{2}}{{q}_{2}} ) {{e}_{2 x} ( {\int }_{0}^{t} {e}_{2 x} dt )}^{{p}_{2} / {q}_{2} - 1} ) \qquad ( 45 )$$

where the macro-variable ζₓ=e₁ₓ+w₁ₓ(∫₀^{t} e₁ₓdt)^{p}^{₁}^{/q}^{₁}+e₂ₓ+w₂ₓ(∫₀^{t} e₂ₓdt)^{p}^{₂}^{/q}^{₂}, the errors

$${e}_{1 x} = {x}_{9} - {x}_{9}^{d} , {e}_{2 x} = {x}_{10} - {x}_{10}^{d} \cdot {w}_{1 x} , {w}_{2 x}$$

and Tₓ are the design constants.

The TSC patched with harmonic disturbance observer for the complete quadrotor system for tracking of states is defined as:

$${F}_{z} = \frac{m}{cos {x}_{3} cos {x}_{5}} ( {\dot{x}}_{2}^{d} + g + {ξ}_{z} \frac{{x}_{2}}{m} - \frac{{ξ}_{x}}{{T}_{z}} - {x}_{2} - {w}_{1 z} ( \frac{{p}_{1}}{{q}_{1}} ) {{e}_{1 z} ( {\int }_{0}^{t} {e}_{1 z} dt )}^{{p}_{1} / {q}_{1} - 1} - {w}_{2 z} ( \frac{{p}_{2}}{{q}_{2}} ) {{e}_{2 z} ( {\int }_{0}^{t} {e}_{2 z} dt )}^{{p}_{2} / {q}_{2} - 1} - {\hat{d}}_{z} ) \qquad ( 46 )$$

$${τ}_{ϕ} = {I}_{x} ( {\dot{x}}_{4}^{d} - {x}_{6} {x}_{8} \frac{( {I}_{1} - {I}_{z} )}{{I}_{x}} + \frac{{I}_{r}}{{I}_{x}} {x}_{6} \overline{ω} + \frac{{ξ}_{ϕ}}{{I}_{x}} {x}_{4} - \frac{{ζ}_{ϕ}}{{T}_{ϕ}} - {x}_{4} - {w}_{1 ϕ} ( \frac{{p}_{1}}{{q}_{1}} ) {{e}_{1 ϕ} ( {\int }_{0}^{t} {e}_{1 ϕ} dt )}^{{p}_{1} / {q}_{1} - 1} - {w}_{2 ϕ} ( \frac{{p}_{2}}{{q}_{2}} ) {{e}_{2 ϕ} ( {\int }_{0}^{t} {e}_{2 ϕ} dt )}^{{p}_{2} / {q}_{2} - 1} - {\hat{d}}_{ϕ} ) - {x}_{6} - {w}_{1 θ} ( \frac{{p}_{1}}{{q}_{1}} ) {{e}_{1 θ} ( {\int }_{0}^{t} {e}_{1 θ} dt )}^{{p}_{1} / {q}_{1} - 1} - {w}_{2 θ} ( \frac{{p}_{2}}{{q}_{2}} ) {{e}_{2 θ} ( {\int }_{0}^{t} {e}_{2 θ} dt )}^{{p}_{2} / {q}_{2} - 1} - {\hat{d}}_{θ} )$$

$${τ}_{ψ} = {I}_{z} ( {\dot{x}}_{8}^{d} - {x}_{4} {x}_{6} \frac{( {I}_{x} - {I}_{y} )}{{I}_{z}} + \frac{{ξ}_{ψ}}{{I}_{z}} {x}_{8} - \frac{{ζ}_{ψ}}{{T}_{ψ}} - {x}_{8} - {w}_{1 ψ} ( \frac{{p}_{1}}{{q}_{1}} ) {{e}_{1 ψ} ( {\int }_{0}^{t} {e}_{1 ψ} dt )}^{{p}_{1} / {q}_{1} - 1} - {w}_{2 ψ} ( \frac{{p}_{2}}{{q}_{2}} ) {{e}_{2 ψ} ( {\int }_{0}^{t} {e}_{2 ψ} dt )}^{{p}_{2} / {q}_{2} - 1} - \hat{{ψ}_{ψ}} )$$

while the control action for x and y axis can be defined as:

$$\begin{matrix}{F}_{x} = \frac{m}{{F}_{z}} ( {\dot{x}}_{10}^{d} - \frac{{ξ}_{x}}{m} {x}_{10} - \frac{ζ}{{T}_{x}} - {x}_{10} - \\ {w}_{1 x} ( \frac{{p}_{1}}{{q}_{1}} ) {{e}_{1 x} ( {\int }_{0}^{t} {e}_{1 x} dt )}^{{p}_{1} / {q}_{1} - 1} - \\ {w}_{2 x} ( \frac{{p}_{2}}{{q}_{2}} ) {{e}_{2 x} ( {\int }_{0}^{t} {e}_{2 x} dt )}^{{p}_{2} / {q}_{2} - 1} - {\hat{d}}_{x} ) \\ {F}_{y} = \frac{m}{{F}_{z}} ( {\dot{x}}_{12}^{d} - \frac{{ξ}_{y}}{m} {x}_{12} - \frac{ζ}{{T}_{y}} - {x}_{12} - \\ {w}_{1 y} ( \frac{{p}_{1}}{{q}_{1}} ) {{e}_{1 y} ( {\int }_{0}^{t} {e}_{1 y} dt )}^{{p}_{1} / {q}_{1} - 1} - \\ {w}_{2 y} ( \frac{{p}_{2}}{{q}_{2}} ) {{e}_{2 y} ( {\int }_{0}^{t} {e}_{2 y} dt )}^{{p}_{2} / {q}_{2} - 1} - {\hat{d}}_{y} )\end{matrix} \} \qquad ( 47 )$$

In a second step a stability analysis of the TSC is performed. The stability analysis is performed using the Lyapunov function. The Lyapunov function can be considered as:

$${V}_{2} = \frac{1}{2} {ζ}^{2} \qquad ( 48 )$$

Taking the time derivative of equation 45:

$${\dot{V}}_{2} = ζ \dot{ζ} \qquad ( 49 )$$

By equating value of \dot{ζ} from equation 42:

$${\dot{V}}_{2} = - \frac{{ζ}^{2}}{{T}_{2}} \qquad ( 50 )$$

By putting in value of ζ² from equation 45:

$${\dot{V}}_{2} = - \frac{2 {V}_{2}}{{T}_{2}} \qquad ( 51 )$$

The solution of equation 51 yields:

$${\dot{V}}_{2} = {V}_{02} {e}^{( - 2 / {T}_{2} ) t} \qquad ( 52 )$$

where V₀₂ is the value of the Lyapunov function at t=0. Therefore equation 52 ensures global exponential finite time stability.

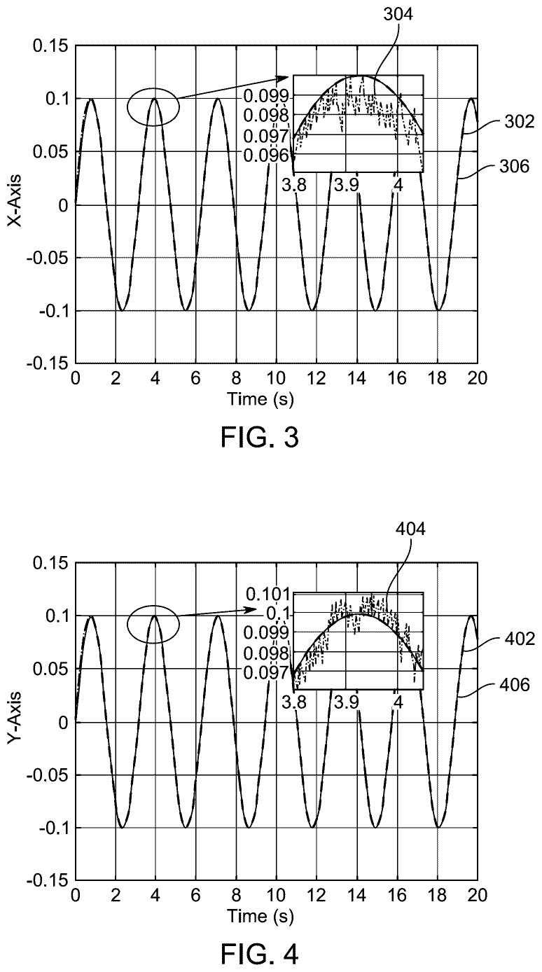

FIG. 3 illustrates a graphical representation of the X-axis disturbance estimation using the NHDO, according to certain embodiments. The X-axis of the graph represents time in seconds, while the Y-axis represents the estimated disturbance magnitude. The reference disturbance signal, denoted as dₓ, is a sinusoidal function with an amplitude of 0.1 and a frequency of 2t, applied to the X-axis.

A first curve 302 represents the actual reference disturbance acting on the X-axis, serving as a benchmark for the estimation accuracy. A second curve 304 represents the estimated disturbance obtained from the NHDO. The NHDO dynamically estimates the external disturbance acting on the UAV's X-axis and refines the control response to minimize deviation.

A third curve 306 corresponds to the disturbance estimation from the Finite Time Disturbance Observer (FTDO) implemented in prior approaches. The performance comparison between the second curve 304 and the third curve 306 demonstrates that the NHDO achieves a more accurate estimation of external disturbances, ensuring minimal tracking error and improved robustness in control execution.

FIG. 4 illustrates a Y-axis disturbance estimation graph. The X-axis represents time in seconds, denoted as time(s), and the Y-axis represents the magnitude of the disturbance affecting the Y-axis motion. The graph includes a reference disturbance trajectory 402, a first disturbance estimation 404 corresponding to the method implemented in a prior technique, and a second disturbance estimation 406 obtained using the NHDO. The reference disturbance trajectory 402 is a sinusoidal signal representing the applied disturbance along the Y-axis. The first disturbance estimation 404 follows an approximation of the reference disturbance trajectory 402 but exhibits deviations from the applied disturbance due to estimation inaccuracies. The second disturbance estimation 406, determined using the NHDO, closely follows the reference disturbance trajectory 402, indicating improved disturbance estimation accuracy compared to the first disturbance estimation 404.

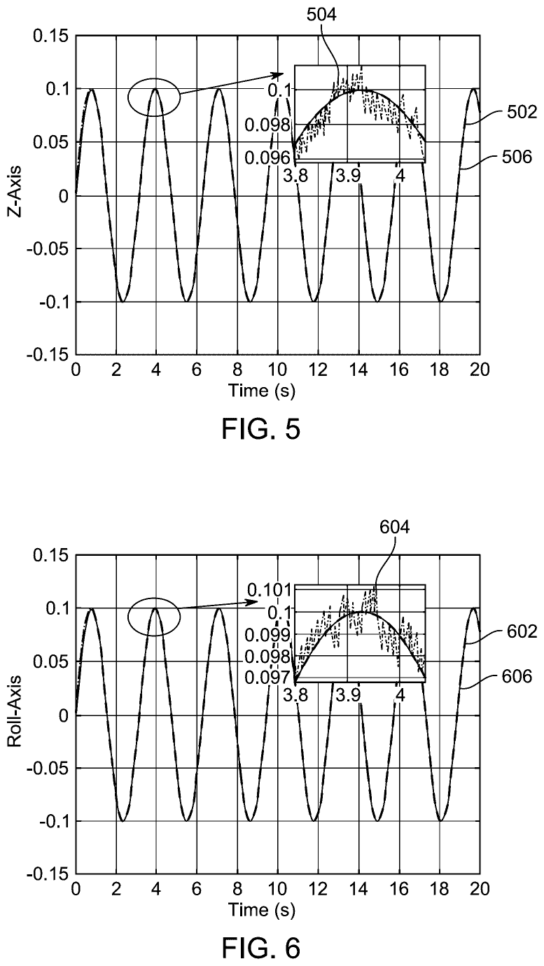

FIG. 5 illustrates a Z-axis disturbance estimation graph. The X-axis represents time in seconds, denoted as time(s), and the Y-axis represents the magnitude of the disturbance acting along the Z-axis. The graph includes a reference disturbance trajectory 502, a first disturbance estimation 504 corresponding to the method implemented in a prior technique, and a second disturbance estimation 506 obtained using the NHDO. The reference disturbance trajectory 502 represents the applied disturbance affecting the vertical motion of the UAV along the Z-axis. The first disturbance estimation 504 demonstrates a deviation from the applied disturbance due to estimation errors inherent in conventional techniques. The second disturbance estimation 506 exhibits an improved response, closely approximating the reference disturbance trajectory 502 and reducing estimation deviations.

FIG. 6 illustrates a roll-axis disturbance estimation graph. The X-axis represents time in seconds, denoted as time(s), and the Y-axis represents the magnitude of the disturbance affecting the roll-axis. The graph includes a reference disturbance trajectory 602, a first disturbance estimation 604 corresponding to the method implemented in a prior technique, and a second disturbance estimation 606 obtained using the NHDO. The reference disturbance trajectory 602 represents the applied disturbance affecting the roll motion of the UAV. The first disturbance estimation 604 exhibits deviations from the reference disturbance trajectory 602, indicating limitations in the estimation accuracy of conventional methods. The second disturbance estimation 606 follows the reference disturbance trajectory 602 more accurately, demonstrating the superior performance of the NHDO in estimating disturbances along the roll-axis.

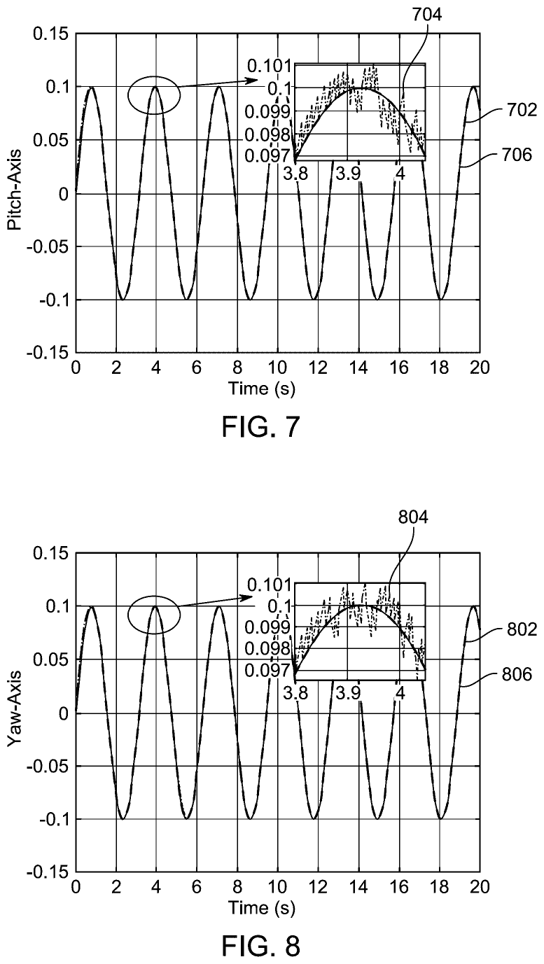

FIG. 7 illustrates a graphical representation of pitch-axis disturbance estimation over time. The X-axis represents time in seconds, while the Y-axis represents the estimated disturbance acting on the pitch-axis. A reference disturbance 702 is plotted as a continuous trajectory, defining the actual external disturbance applied to the system. A first disturbance estimation trajectory 704, corresponding to the disturbance observer implemented in a prior system, is depicted as a separate trajectory. A second disturbance estimation trajectory 706, corresponding to the NHDO, is plotted to demonstrate the enhanced estimation accuracy. A magnified section highlights a specific region for detailed evaluation.

FIG. 8 illustrates a graphical representation of yaw-axis disturbance estimation over time. The X-axis represents time in seconds, while the Y-axis represents the estimated disturbance acting on the yaw-axis. The reference disturbance 802, the first disturbance estimation trajectory 804 corresponding to the prior system, and the second disturbance estimation trajectory 806 corresponding to the NHDO are plotted.

To analyze the performance of the controllers designed multiple performance indices would be used i.e., IAE (Integral Absolute Error), ITAE (Integral Time Absolute Error), ISE (Integral Square Error) and ITSE (Integral Time Square Error). The formulas for the performance index are as follows:

$$IAE = {\int }_{0}^{t} \vert e \vert dt$$

$$ITAE = {\int }_{0}^{t} \vert te \vert dt$$

$$ISE = {\int }_{0}^{t} {e}^{2} dt$$

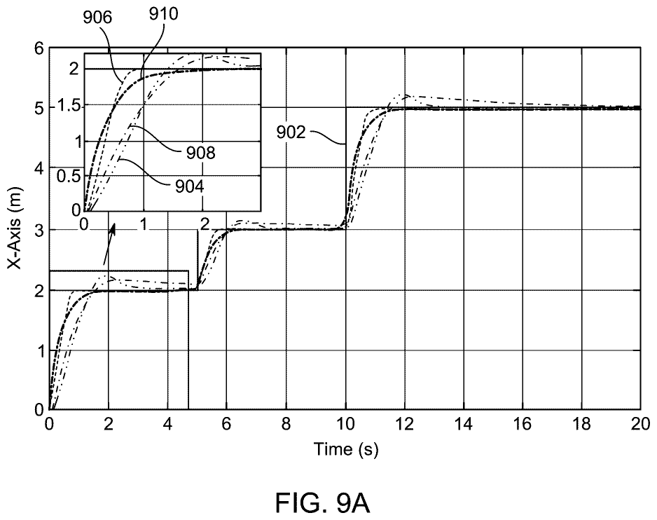

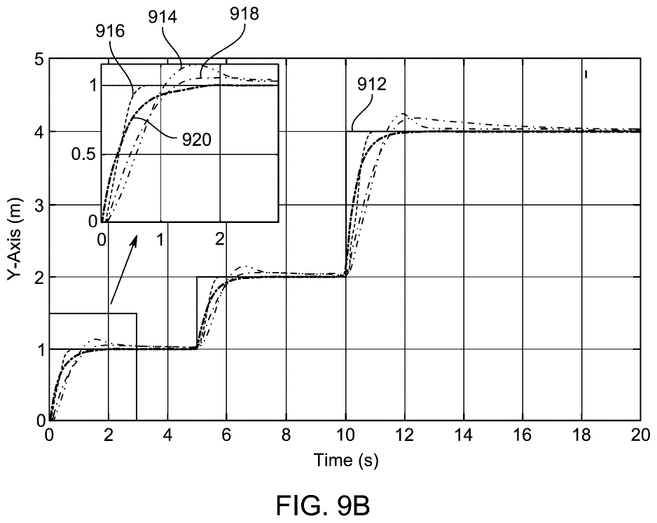

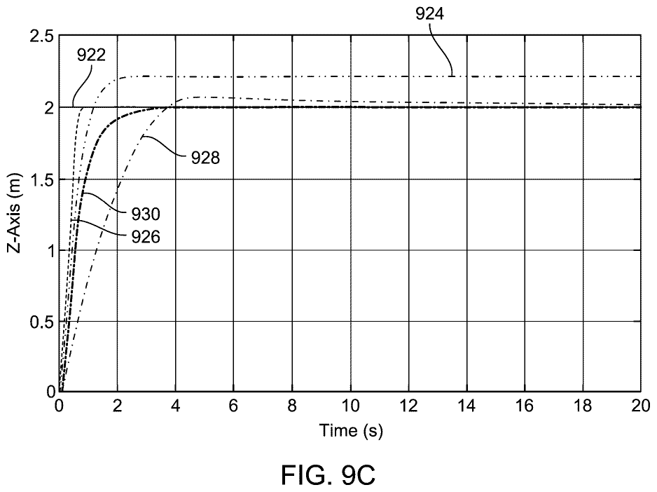

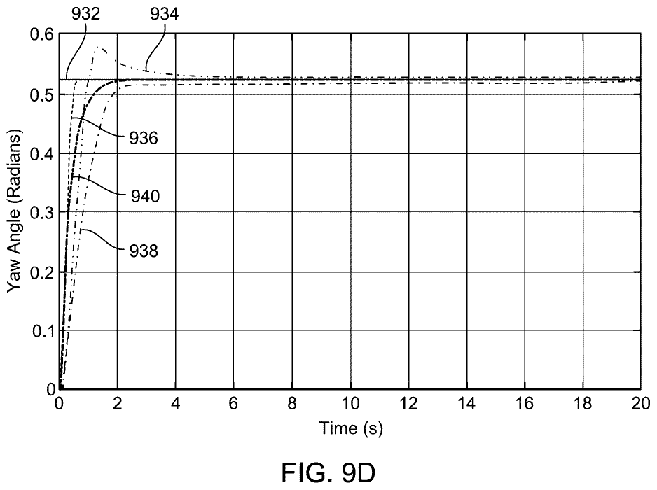

FIG. 9A illustrates a multi-step input response along the X-axis, depicting the trajectory tracking performance of different control approaches. The X-axis represents time in seconds, while the Y-axis represents the position along the X-axis in meters. Curve 902 represents a reference trajectory indicated as a baseline for comparison. Curve 904 corresponds to a finite-time super-twisting sliding mode controller, exhibiting deviations from the reference trajectory. Curve 906 represents the RFBL controller, which achieves improved trajectory tracking performance. Curve 908 represents the integral sliding mode controller (ISMC), demonstrating a stable convergence response. Curve 910 represents the TSC, maintaining a comparable tracking performance to the ISMC.

FIG. 9B illustrates a multi-step input response along the Y-axis, representing the control system's ability to track a predefined Y-axis trajectory. The X-axis represents time in seconds, while the Y-axis represents the position along the Y-axis in meters. Curve 912 represents a reference trajectory serving as a comparative baseline. Curve 914 represents a finite-time super-twisting sliding mode controller, which exhibits deviations from the reference trajectory. Curve 916 represents the RFBL controller, following the reference trajectory with greater precision. Curve 918 represents the ISMC, demonstrating smooth trajectory tracking. Curve 920 represents the TSC, achieving a trajectory-tracking response comparable to the ISMC.

FIG. 9C illustrates a multi-step input response along the Z-axis, representing altitude tracking performance. The X-axis represents time in seconds, while the Y-axis represents the position along the Z-axis in meters. Curve 922 represents a reference trajectory defining the expected altitude variation. Curve 924 represents a finite-time super-twisting sliding mode controller, exhibiting deviations from the reference trajectory. Curve 926 represents the RFBL controller, ensuring improved altitude tracking performance. Curve 928 represents the ISMC, demonstrating effective convergence to the reference trajectory. Curve 930 represents the TSC, maintaining stable tracking performance.

FIG. 9D illustrates a multi-step input response along the yaw-axis (w), representing the rotational motion of the UAV about the vertical axis. The X-axis represents time in seconds, while the Y-axis represents the yaw angle in radians. Curve 932 represents a reference trajectory serving as the expected yaw angle variation. Curve 934 represents a finite-time super-twisting sliding mode controller, demonstrating deviations from the reference trajectory. Curve 936 represents the RFBL controller, following the reference trajectory with improved tracking accuracy. Curve 938 represents the ISMC, ensuring a stable response. Curve 940 represents the TSC, maintaining a trajectory-tracking response similar to the ISMC.

FIGS. 9A-9D are the result of the design of multi-step input trajectory. For the design of multi-step input trajectory, x^{d} and y^{d} are varied, while z and ψ are kept constant at z^{d}=2 and ψ^{d}=π/6 respectively.

$${x}^{d} = \{ \begin{matrix}2 , & 0 < t \leq 5 \\ 3 , & 5 < t \leq 10 \\ 5 , & t > 10\end{matrix}$$

$${y}^{d} = \{ \begin{matrix}1 , & 0 < t \leq 5 \\ 2 , & 5 < t \leq 10 \\ 4 , & t > 10\end{matrix}$$

TABLE 1
Specification for X -axis (multi-input trajectory)

| Controller Type | IAE | ITAE | ISE | ITSE |
|---|---|---|---|---|
| RFBL controller | 1.81 | 9.47 | 2.338 | 12.09 |
| Finite-time super twisting | 4.15 | 23.85 | 4.73 | 25.29 |
| sliding mode controller | | | | |
| ISMC | 4.561 | 30.82 | 3.933 | 21.06 |
| TSC | 1.927 | 10.56 | 1.724 | 8.883 |

TABLE 2
Specification for Y-axis (multi-input trajectory).

| Controller Type | IAE | ITAE | ISE | ITSE |
|---|---|---|---|---|
| RFBL controller | 1.368 | 9.34 | 1.499 | 11.93 |
| Finite-time super twisting | 3.211 | 23.25 | 3.028 | 24.64 |
| sliding mode controller | | | | |
| ISMC | 3.405 | 28.76 | 2.522 | 20.87 |
| TSC | 1.54 | 10.34 | 1.147 | 8.783 |

TABLE 3
Specification for Z-axis (multi-input trajectory).

| Controller Type | IAE | ITAE | ISE | ITSE | tₛ(sec) |
|---|---|---|---|---|---|
| RFBL controller | 0.6873 | 0.1493 | 0.975 | 0.1542 | 0.6985 |
| Finite-time super | 4.902 | 42.82 | 2.028 | 9.348 | N/A |
| twisting sliding | | | | | |
| mode controller | | | | | |
| ISMC | 3.515 | 9.564 | 3.609 | 2.749 | 11.3011 |
| TSC | 1.445 | 1.124 | 1.751 | 0.5289 | 2.3698 |

TABLE 4
Specification for Yaw (ψ)-axis (multi-input trajectory).

| Controller Type | IAE | ITAE | ISE | ITSE | tₛ(sec) |
|---|---|---|---|---|---|
| RFBL controller | 0.1358 | 0.02216 | 0.05092 | 0.006052 | 0.5335 |
| Finite-time super | 0.3802 | 0.5432 | 0.1089 | 0.03055 | 3.5545 |
| twisting sliding | | | | | |
| mode controller | | | | | |
| ISMC | 0.5104 | 0.95 | 3.609 | 0.1422 | 3.0573 |
| TSC | 0.2041 | 0.1217 | 0.05415 | 0.009887 | 1.4737 |

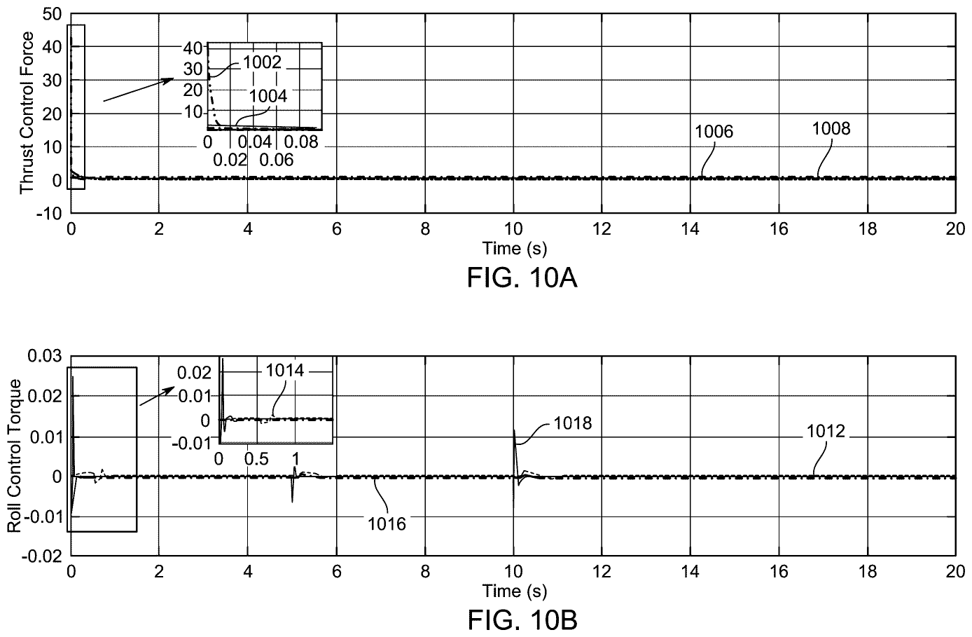

In FIG. 10A, the x-axis represents time in seconds, while the y-axis represents thrust control force. Curve 1002 corresponds to the finite-time super twisting sliding mode controller, serving as a reference for comparison. Curve 1004 represents the RFBL controller, curve 1006 corresponds to the ISMC, and curve 1008 represents the TSC. The inset within FIG. 10A highlights the response behavior in the initial transient phase, where the thrust force experiences a rapid transition before stabilizing.

In FIG. 10B, the x-axis represents time in seconds, while the y-axis represents roll control torque. Curve 1012 corresponds to the finite-time super twisting sliding mode controller, curve 1014 represents the RFBL controller, curve 1016 denotes the ISMC, and curve 1018 corresponds to the TSC. The inset within FIG. 10B illustrates a magnified view of the roll torque variations during the transient phase, emphasizing the comparative performance of the control methodologies.

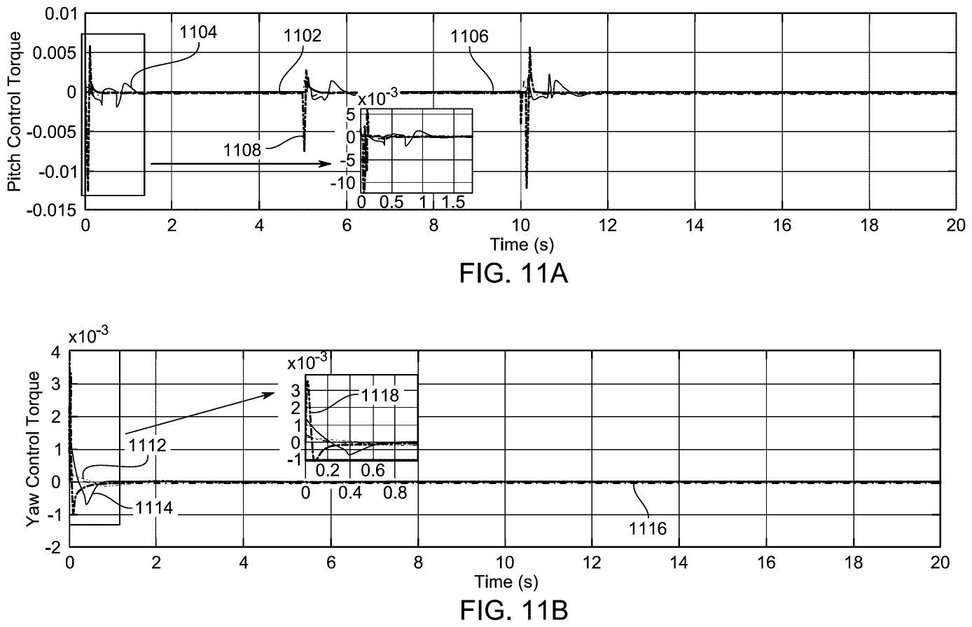

In FIG. 11A, the x-axis represents time in seconds, while the y-axis represents pitch control torque. Curve 1102 corresponds to the finite-time super twisting sliding mode controller, curve 1104 represents the RFBL controller, curve 1106 denotes the ISCM, and curve 1108 corresponds to the TSC. The inset within FIG. 11A provides a zoomed-in view of the pitch torque variations in the initial phase, depicting the transient response of each controller.

In FIG. 11B, the x-axis represents time in seconds, while the y-axis represents yaw control torque. Curve 1112 corresponds to the finite-time super twisting sliding mode controller, curve 1114 represents the RFBL controller, curve 1116 denotes the ISCM, and curve 1118 corresponds to the TSC. The inset within FIG. 11B highlights a magnified view of the yaw torque variations, indicating differences in the controllers' response to dynamic disturbances.

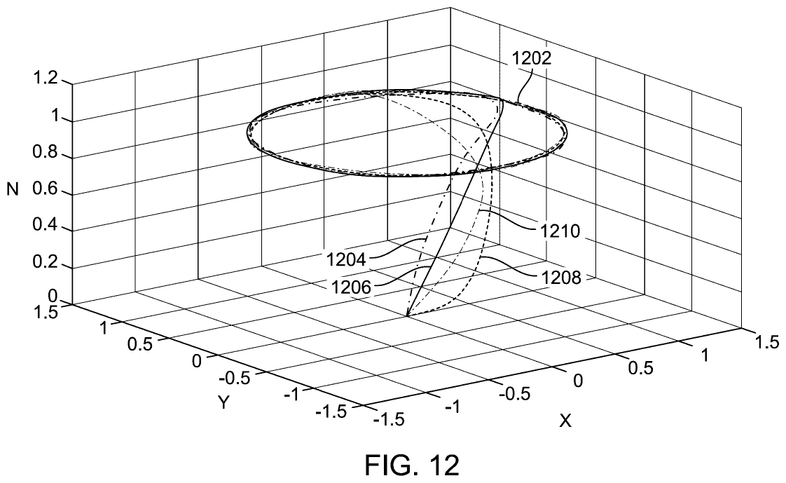

FIG. 12 illustrates a circular trajectory plot for a quadcopter unmanned aerial vehicle (UAV). To achieve a circular trajectory, an altitude of 1 m to track the z-axis is given, while the yaw angle ψ is kept at 0 rad. The desired trajectory to track for the x and y axis is: x^{d}=cos(0.5t) and y^{d}=cos(0.5t). The reference trajectory 1202 represents the desired circular path for the UAV, serving as a baseline for evaluating the tracking performance of various controllers. Curve 1204 depicts the trajectory tracked by the finite-time super twisting sliding mode controller with a finite-time disturbance observer (FTDO). Curve 1206 represents the trajectory tracked using a robust feedback linearization (RFBL) controller with a harmonic disturbance observer. Curve 1208 illustrates the trajectory performance using an integral sliding mode controller (ISMC) with a harmonic disturbance observer. Curve 1210 corresponds to the trajectory tracking achieved with the TSC with a harmonic disturbance observer. The x-axis represents the UAV's displacement along the x-coordinate, the y-axis represents displacement along the y-coordinate, and the z-axis represents altitude. The performance of each controller is evaluated based on the closeness of the estimated trajectory to the reference trajectory 1202, with the RFBL controller exhibiting superior accuracy and stability in maintaining the circular trajectory.

The data presented in Tables 5, 6, and 7 demonstrates the superior performance of the RFBL controller. The TSC exhibits significant spikes, which adversely impact its effectiveness. The performance index further indicates that the RFBL controller surpasses all other controllers, including the Finite-time super twisting sliding mode controller, as disclosed in reference [V. K. Tripathi, A. K. Kamath, L. Behera, N. K. Verma, and S. Nahavandi, “Finite-time super twisting sliding mode controller based on higher-order sliding mode observer for real-time trajectory tracking of a quadrotor,” IET Control Theory Appl., vol. 14, no. 16, pp. 2359-2371 November 2020].

TABLE 5
Specification for X -axis (circular trajectory).

| Controller Type | IAE | ITAE | ISE | ITSE |
|---|---|---|---|---|
| RFBL controller | 1.045 | 7.353 | 0.2528 | 0.3782 |
| Finite-time super twisting | 3.067 | 24.11 | 0.8191 | 3.61 |
| sliding mode controller | | | | |
| ISMC | 2.617 | 20.3 | 0.666 | 3.008 |
| TSC | 2.557 | 22.57 | 0.5141 | 3.291 |

TABLE 6
Specification for Y -axis (circular trajectory).

| Controller Type | IAE | ITAE | ISE | ITSE |
|---|---|---|---|---|
| RFBL controller | 0.7764 | 7.985 | 0.03748 | 0.3891 |
| Finite-time super twisting | 2.567 | 26.09 | 0.3881 | 3.953 |
| sliding mode controller | | | | |
| ISMC | 2.134 | 22.42 | 0.3063 | 3.341 |
| TSC | 2.374 | 24.54 | 0.3474 | 3.693 |

TABLE 7
Specification for Z-axis (circular trajectory).

| Controller Type | IAE | ITAE | ISE | ITSE | tₛ (sec) |
|---|---|---|---|---|---|
| RFBL controller | 0.2841 | 0.05047 | 0.2301 | 0.02649 | 0.5803 |
| Finite-time super twisting | 0.5248 | 0.5584 | 0.2704 | 0.05723 | 2.2369 |
| sliding mode controller | | | | | |
| ISMC | 1.179 | 1.609 | 0.6917 | 0.3686 | 2.6984 |
| TSC | 0.7498 | 0.5562 | 0.4857 | 0.1519 | 2.2203 |

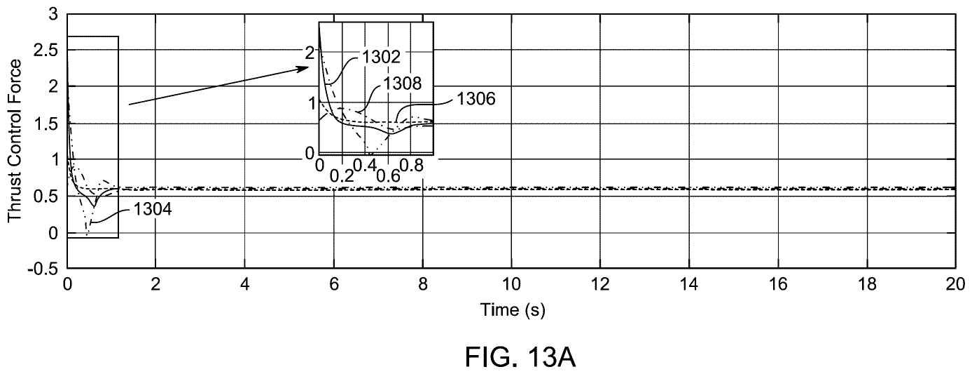

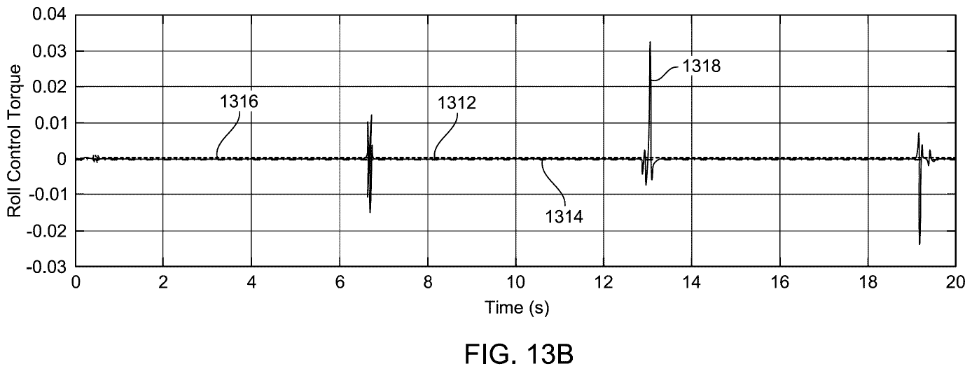

FIG. 13A illustrates the thrust control force required for the UAV to track the circular trajectory. The x-axis represents time in seconds, while the y-axis represents the thrust control force applied to the UAV. Curve 1302 depicts the thrust force generated by the finite-time super twisting sliding mode controller. Curve 1304 represents the thrust force applied by the RFBL controller. Curve 1306 shows the thrust control response of the ISMC, while curve 1308 corresponds to the thrust control response of the TSC. The inset in FIG. 13A highlights the initial phase of the thrust control application, where the RFBL controller achieves a smoother and more stable control force, demonstrating superior disturbance rejection and trajectory tracking.

FIG. 13B illustrates the roll control torque applied to the UAV for maintaining stability during circular trajectory tracking. The x-axis represents time in seconds, while the y-axis represents the roll control torque. Curve 1312 represents the roll torque applied by the finite-time super twisting sliding mode controller. Curve 1314 corresponds to the roll torque applied by the RFBL controller. Curve 1316 represents the roll torque response using the ISMC, and curve 1318 illustrates the roll torque response using the TSC. The RFBL controller exhibits minimal oscillations and improved control precision compared to the other controllers.

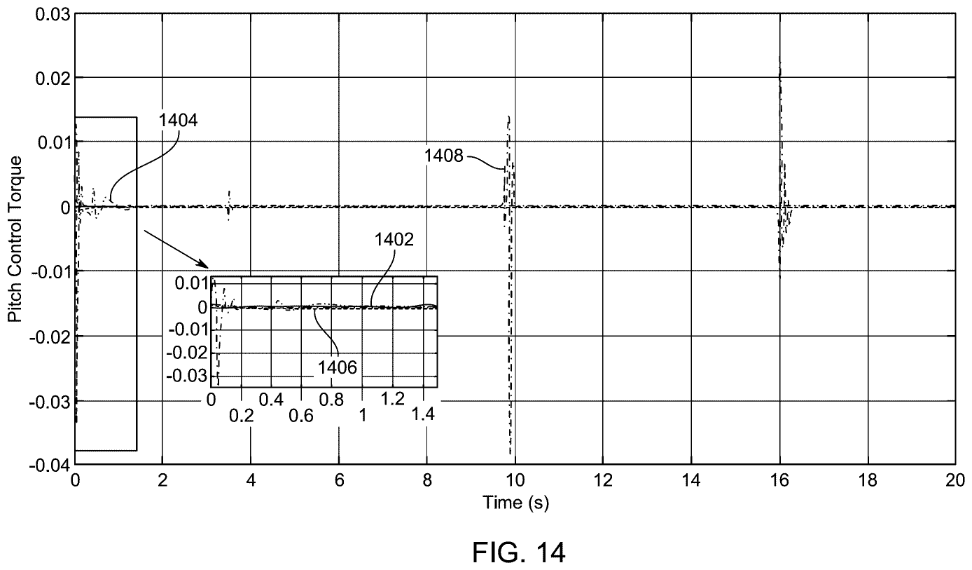

FIG. 14 illustrates the pitch control torque required for achieving the circular trajectory. The x-axis represents time in seconds, while the y-axis represents the pitch control torque applied to the UAV. Curve 1402 represents the pitch torque applied by the finite-time super twisting sliding mode controller. Curve 1404 corresponds to the pitch torque applied by the RFBL controller. Curve 1406 represents the pitch torque response using the ISMC, and curve 1408 illustrates the pitch torque response using the TSC. The inset in FIG. 14 highlights the initial transient response, where the RFBL controller achieves a smoother and more stable control response with minimal oscillations, demonstrating superior control performance and disturbance rejection.

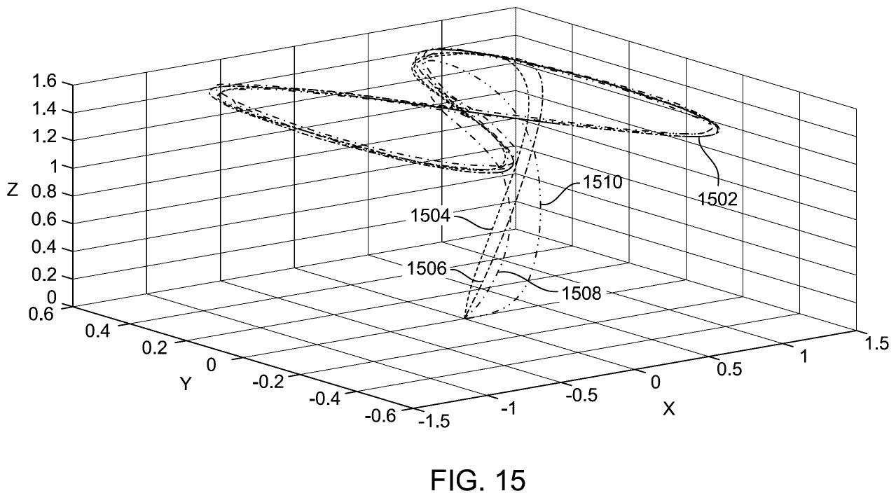

FIG. 15 illustrates the trajectory tracking performance of the controllers for an eight-shaped or infinity trajectory. The plot represents the reference trajectory, indicated by curve 1502, serving as a baseline for performance comparison. The trajectory followed by the controller is represented by curve 1504, while the trajectory executed by the RFBL controller with a Harmonic Disturbance Observer is represented by curve 1506. The trajectory corresponding to the ISMC with a Harmonic Disturbance Observer is denoted by curve 1508, while the TSC with a Harmonic Disturbance Observer follows curve 1510. The graph is plotted in a three-dimensional space, with the X-axis and Y-axis representing lateral and longitudinal displacements, respectively, while the Z-axis corresponds to altitude.

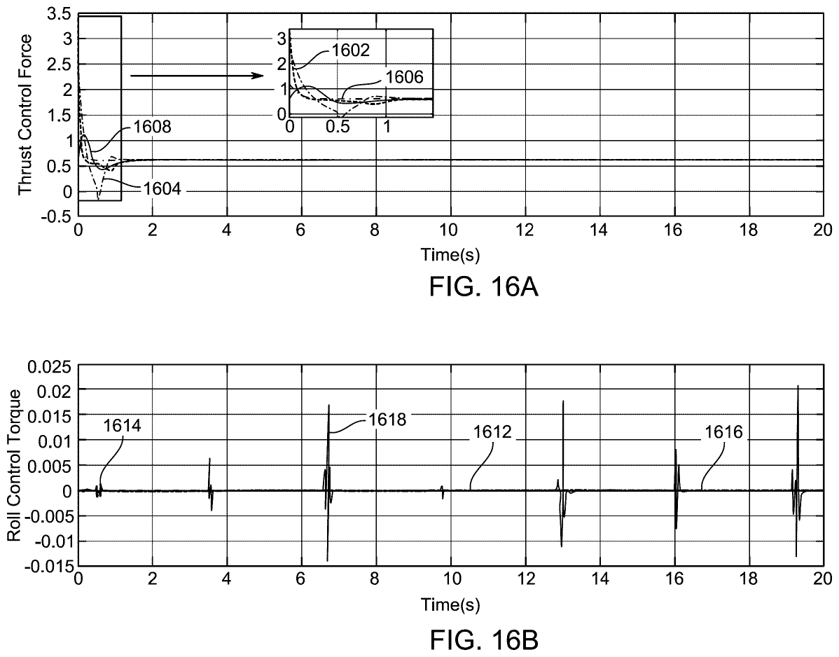

FIG. 16 presents the control input response for achieving the eight-shaped trajectory. FIG. 16A illustrates the thrust control force applied by various controllers to maintain the trajectory, with the X-axis representing time and the Y-axis representing thrust control force. Curve 1602 represents the thrust force generated by the Finite-time super twisting sliding mode controller, while curve 1604 corresponds to the RFBL controller. Curve 1606 represents the ISCM, and curve 1608 denotes the TSC. FIG. 16B illustrates the roll control torque required to maintain stability during the maneuver. The X-axis represents time, while the Y-axis represents roll control torque. The roll control torque applied by the Finite-time super twisting sliding mode controller is represented by curve 1612, while curve 1614 corresponds to the RFBL controller. Curve 1616 represents the ISCM, and curve 1618 denotes the TSC.

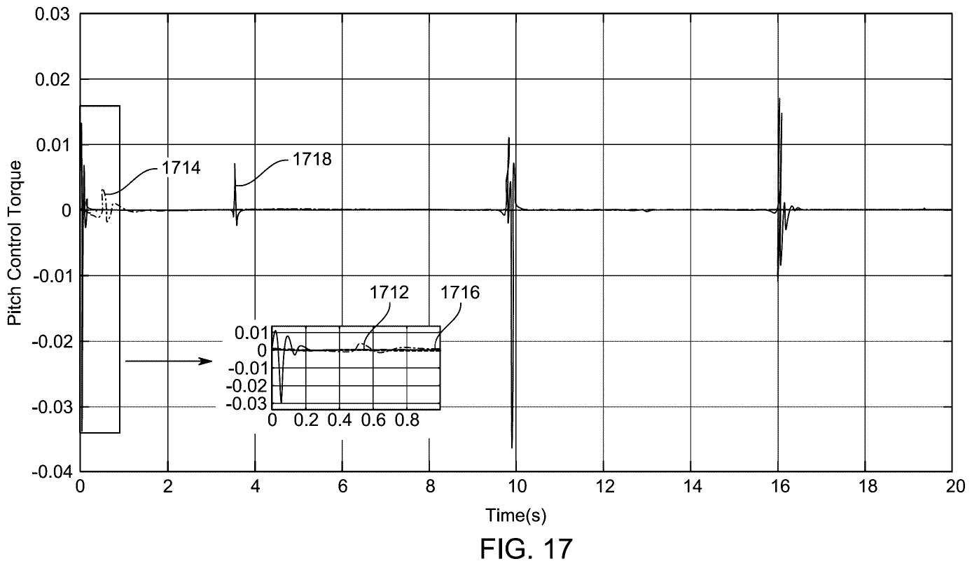

FIG. 17 depicts the control action in terms of pitch control torque during the execution of the eight-shaped trajectory. The X-axis represents time, while the Y-axis represents the applied pitch control torque. The pitch control torque applied by the Finite-time super twisting sliding mode controller is represented by curve 1712, while curve 1714 corresponds to the RFBL controller. Curve 1716 represents the ISCM, and curve 1718 denotes the TSC. The response of the controllers is analyzed in terms of smoothness, stability, and transient behavior.

TABLE 9
Specification for X-axis (infinity shaped trajectory)

| Controller Type | IAE | ITAE | ISE | ITSE |
|---|---|---|---|---|
| RFBL controller | 1.045 | 7.353 | 0.2528 | 0.3782 |
| Finite-time super twisting | 3.067 | 24.11 | 0.8191 | 3.61 |
| sliding mode controller | | | | |
| ISMC | 2.617 | 20.3 | 0.666 | 3.008 |
| TSC | 2.557 | 22.57 | 0.5141 | 3.291 |

TABLE 9
Specification for Y -axis (infinity shaped trajectory).

| Controller Type | IAE | ITAE | ISE | ITSE |
|---|---|---|---|---|
| RFBL controller | 0.837 | 8.528 | 0.04428 | 0.4544 |
| Finite-time super twisting | 2.595 | 26.42 | 0.4137 | 4.244 |
| sliding mode controller | | | | |
| ISMC | 2.05 | 21.32 | 0.2722 | 2.903 |
| TSC | 2.274 | 23.49 | 0.3189 | 3.376 |

TABLE 10
Specification for Z-axis (infinity shaped trajectory).

| Controller Type | IAE | ITAE | ISE | ITSE | tₛ (sec) |
|---|---|---|---|---|---|
| RFBL controller | 0.4759 | 0.09486 | 0.5083 | 0.07416 | 0.6443 |
| Finite-time super twisting | 0.8686 | 0.7317 | 0.7347 | 0.1813 | 2.0092 |
| sliding mode controller | | | | | |
| ISMC | 2.253 | 4.989 | 1.817 | 1.186 | 6.3582 |
| TSC | 1.099 | 0.8388 | 1.026 | 0.3128 | 2.3192 |

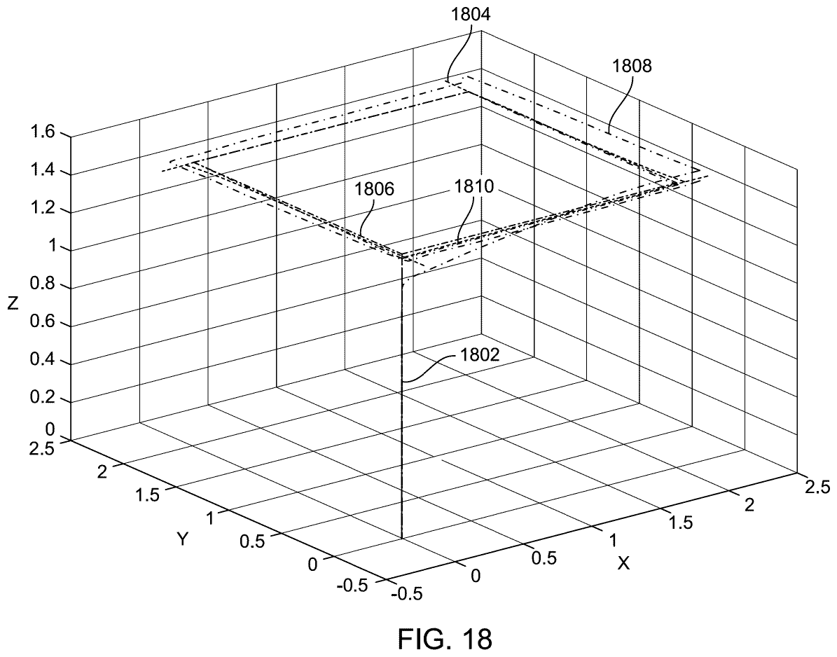

FIG. 18 illustrates the trajectory tracking performance of the controllers for a square-shaped trajectory. The reference trajectory is indicated by curve 1802, serving as a baseline for comparison. The trajectory executed by the Finite-time super twisting sliding mode controller is represented by curve 1804, while the trajectory followed by the RFBL controller with a Harmonic Disturbance Observer is represented by curve 1806. The ISMC with a Harmonic Disturbance Observer follows curve 1808, while the TSC with a Harmonic Disturbance Observer is represented by curve 1810. The plot is presented in a three-dimensional space, with the X-axis and Y-axis representing lateral and longitudinal displacements, respectively, and the Z-axis corresponding to altitude.

The commanded trajectory for the square shape trajectory case is achieved by setting z^{d}=1.5, ψ^{d}=0. While x^{d} and y^{d} are set as:

$${x}^{d} = \{ \begin{matrix}0 , & 0 < t \leq 2.5 \\ 2 , & 2.5 < t \leq 10 \\ 0 , & 10 < t \leq 15 \\ 2 , & t > 15\end{matrix}$$

$${y}^{d} = \{ \begin{matrix}0 , & 0 < t \leq 5 \\ 2 , & 5 < t \leq 12.5 \\ 0 , & t > 12.5\end{matrix}$$

TABLE 11
Specification for X-axis (square shaped trajectory).

| Controller Type | IAE | ITAE | ISE | ITSE |
|---|---|---|---|---|
| RFBL controller | 2.246 | 21.1 | 3.165 | 29.49 |
| Finite-time super twisting | 5.094 | 50.18 | 6.458 | 61.55 |
| sliding mode controller | | | | |
| ISMC | 5.488 | 55.64 | 5.778 | 56.09 |
| TSC | 2.184 | 20.43 | 2.197 | 19.95 |

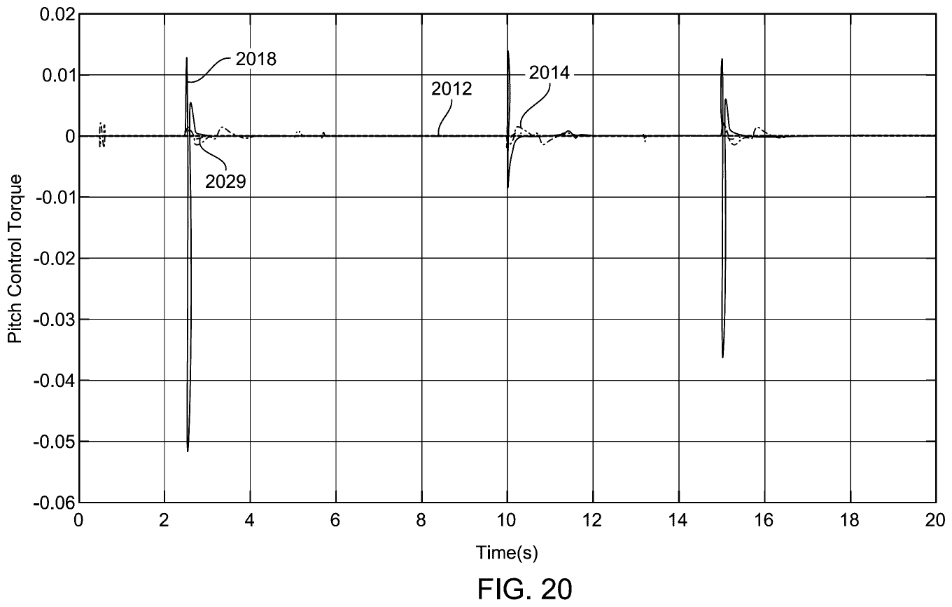

For the square trajectory tracking, the TSC achieves marginally better results than the RFBL controller for the X and Y axes, as indicated in Tables 11 and 12. However, the RFBL controller demonstrates significantly superior performance in the Z axis, as evidenced in Table 13. The advantage of the TSC in the X and Y axes appears to be offset by the presence of high spike content in its control effort, as observed in FIG. 8 and FIG. 20.

TABLE 12
Specification for Y-axis (square shaped trajectory).

| Controller Type | IAE | ITAE | ISE | ITSE |
|---|---|---|---|---|
| RFBL controller | 1.481 | 13.31 | 2.069 | 18.46 |
| Finite-time super twisting | 3.375 | 32.01 | 4.214 | 38.46 |
| sliding mode controller | | | | |
| ISMC | 3.79 | 38.49 | 3.707 | 34.32 |
| TSC | 1.462 | 13.11 | 1.492 | 13.24 |

TABLE 13
Specification for Z-axis (square shaped trajectory).

| Controller Type | IAE | ITAE | ISE | ITSE | tₛ (sec) |
|---|---|---|---|---|---|
| RFBL controller | 0.4759 | 0.09486 | 0.5083 | 0.07416 | 0.6443 |
| Finite-time super twisting | 0.8686 | 0.7317 | 0.7347 | 0.1813 | 2.0092 |
| sliding mode controller | | | | | |
| ISMC | 2.253 | 4.989 | 1.817 | 1.186 | 6.3582 |
| TSC | 1.099 | 0.8388 | 1.026 | 0.3128 | 2.3192 |

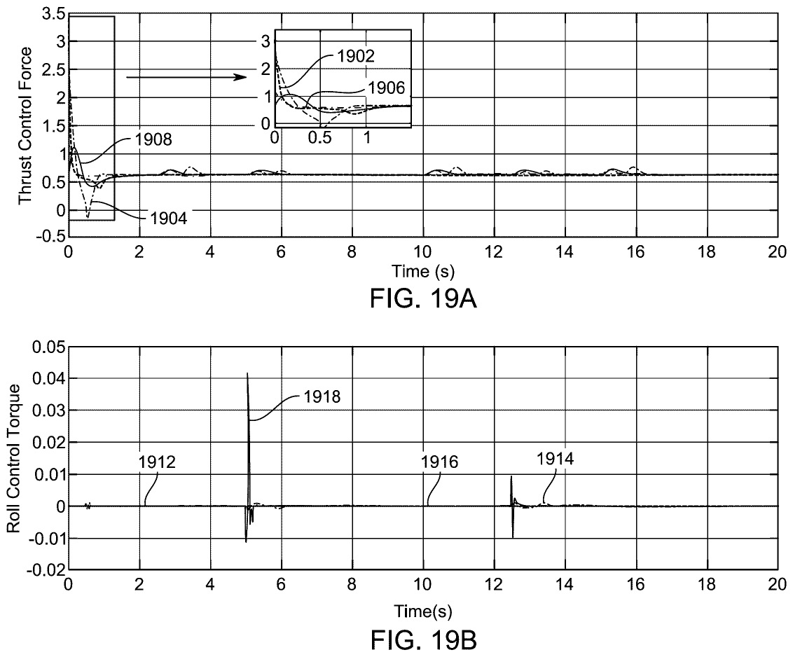

FIG. 19A illustrates the thrust control force applied during the square-shaped trajectory tracking. The horizontal axis represents time in seconds, while the vertical axis represents thrust control force. Curve 1902 represents the control response of the finite-time super twisting sliding mode controller. Curve 1904 represents the RFBL controller response. Curve 1906 corresponds to the ISMC response. Curve 1908 represents the TSC response. The graph demonstrates the comparative performance of each controller, where the RFBL controller achieves a smooth transition with minimal overshoot compared to the Finite-time super twisting sliding mode controller.

FIG. 19B illustrates the roll control torque applied during the square-shaped trajectory tracking. The horizontal axis represents time in seconds, while the vertical axis represents roll control torque. Curve 1912 represents the control response of the finite-time super twisting sliding mode controller. Curve 1914 represents the RFBL controller response. Curve 1916 corresponds to the ISCM response. Curve 1918 represents the TSC response. The results indicate that the RFBL controller provides an optimized torque control effort with reduced oscillations.

FIG. 20 illustrates the pitch control torque applied during the square-shaped trajectory tracking. The horizontal axis represents time in seconds, while the vertical axis represents pitch control torque. Curve 2012 represents the control response of the finite-time super twisting sliding mode controller. Curve 2014 represents the RFBL controller response. Curve 2029 corresponds to the ISCM response. Curve 2018 represents the TSC response. The results demonstrate that the RFBL controller minimizes torque fluctuations, providing a stable pitch control.

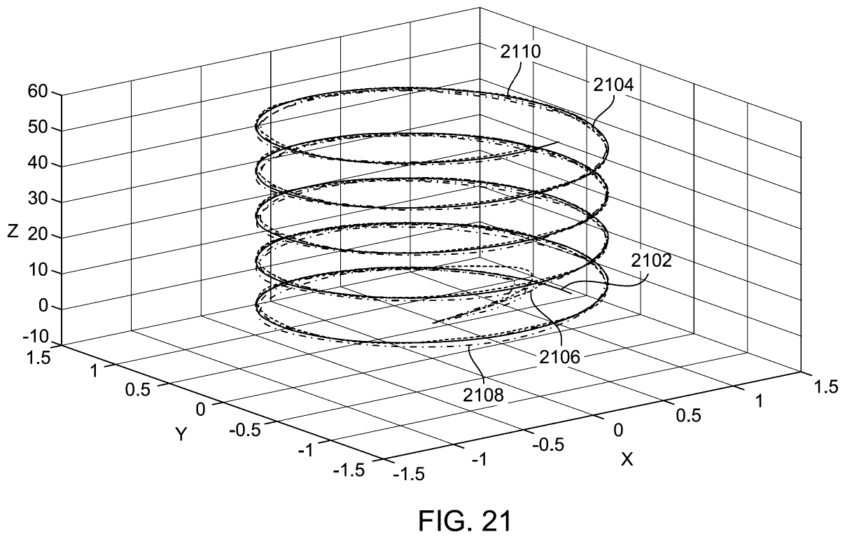

FIG. 21 illustrates the three-dimensional plot of the spiral trajectory tracking. To achieve a spiral trajectory, the yaw angle ψ is kept at 0 rad. The desired trajectory to track for the x, y and z axis is: x^{d}=cos(0.5t), y^{d}=cos(0.5t) and z^{d}=t.

The three axes represent the spatial coordinates X, Y, and Z. Curve 2102 represents the reference trajectory serving as a baseline for comparison. Curve 2104 represents the trajectory tracking performance of the finite-time super twisting sliding mode controller. Curve 2106 represents the trajectory tracking performance of the RFBL controller with the harmonic disturbance observer. Curve 2108 corresponds to the ISCM with the harmonic disturbance observer. Curve 2110 represents the TSC with the harmonic disturbance observer. The RFBL controller exhibits precise trajectory tracking with minimal deviation from the reference trajectory.

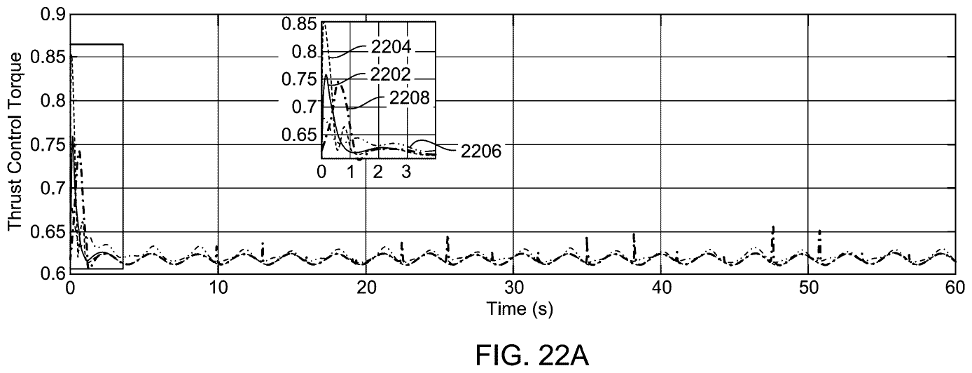

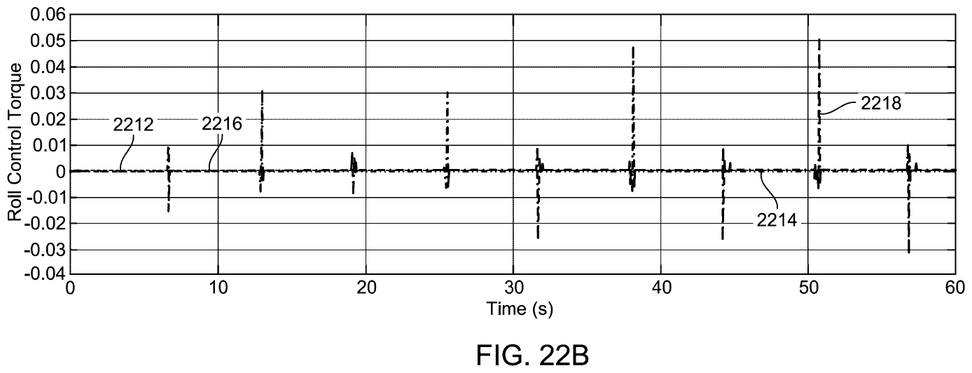

FIG. 22A illustrates the thrust control force applied during the spiral trajectory tracking. The horizontal axis represents time in seconds, while the vertical axis represents thrust control force. Curve 2202 represents the control response of the finite-time super twisting sliding mode controller. Curve 2204 represents the RFBL controller response. Curve 2206 corresponds to the ISCM response. Curve 2208 represents the TSC response. The RFBL controller achieves a rapid and stable thrust response with minimal overshoot.

FIG. 22B illustrates the roll control torque applied during the spiral trajectory tracking. The horizontal axis represents time in seconds, while the vertical axis represents roll control torque. Curve 2212 represents the control response of the finite-time super twisting sliding mode controller. Curve 2214 represents the RFBL controller response. Curve 2216 corresponds to the ISCM response. Curve 2218 represents the TSC response. The RFBL controller demonstrates superior roll torque control, reducing high-frequency oscillations.

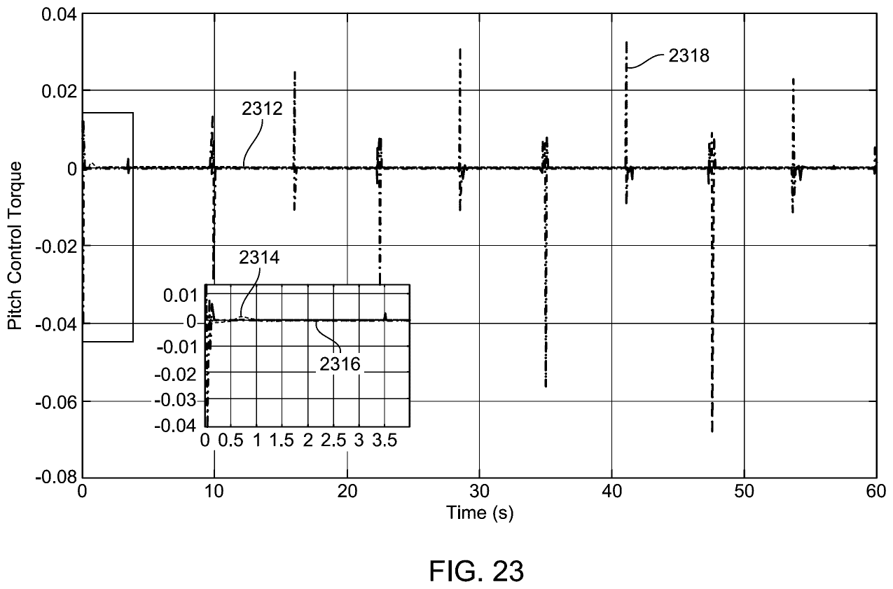

FIG. 23 illustrates the pitch control torque applied during the spiral trajectory tracking. The horizontal axis represents time in seconds, while the vertical axis represents pitch control torque. Curve 2312 represents the control response of the finite-time super twisting sliding mode controller. Curve 2314 represents the RFBL controller response. Curve 2316 corresponds to the ISCM response. Curve 2318 represents the TSC response. The RFBL controller effectively suppresses torque oscillations, resulting in stable pitch control throughout the trajectory execution.

FIG. 21-FIG. 23 represents the spiral trajectory. To evaluate the effectiveness of the RFBL controller in comparison with other controllers, a spiral trajectory has been utilized. The results obtained by the RFBL controller surpass those of all other controllers by a significant margin, as presented in Tables 14, 15, and 16. The RFBL controller exhibits the highest accuracy in tracking the X, Y, and Z axes, which is explicitly demonstrated by the values highlighted in bold.

TABLE 14
Specification for X -axis (spiral trajectory).

| Controller Type | IAE | ITAE | ISE | ITSE |
|---|---|---|---|---|
| RFBL controller | 2.655 | 71.45 | 0.3335 | 3.59 |
| Finite-time super twisting | 8.182 | 227.6 | 1.581 | 33.86 |
| sliding mode controller | | | | |
| ISMC | 6.933 | 191.7 | 1.291 | 27.8 |
| TSC | 7.419 | 216.6 | 1.257 | 33.12 |

TABLE 15
Specification for Y-axis (spiral trajectory).

| Controller Type | IAE | ITAE | ISE | ITSE |
|---|---|---|---|---|
| RFBL controller | 2.253 | 67.21 | 0.1064 | 3.164 |
| Finite-time super twisting | 7.551 | 226.2 | 1.117 | 33.28 |
| sliding mode controller | | | | |
| ISMC | 6.319 | 190.8 | 0.9072 | 27.64 |
| TSC | 7.101 | 214.4 | 1.056 | 32.26 |

TABLE 16
Specification for Z-axis (spiral trajectory).

| Controller Type | IAE | ITAE | ISE | ITSE |
|---|---|---|---|---|
| RFBL controller | 6.117 | 180.2 | 0.6286 | 18.04 |
| Finite-time super twisting | 19.83 | 592.8 | 6.571 | 195.3 |
| sliding mode controller | | | | |
| ISMC | 74.87 | 2061 | 98.12 | 2422 |
| TSC | 40.45 | 1232 | 27.38 | 843.3 |

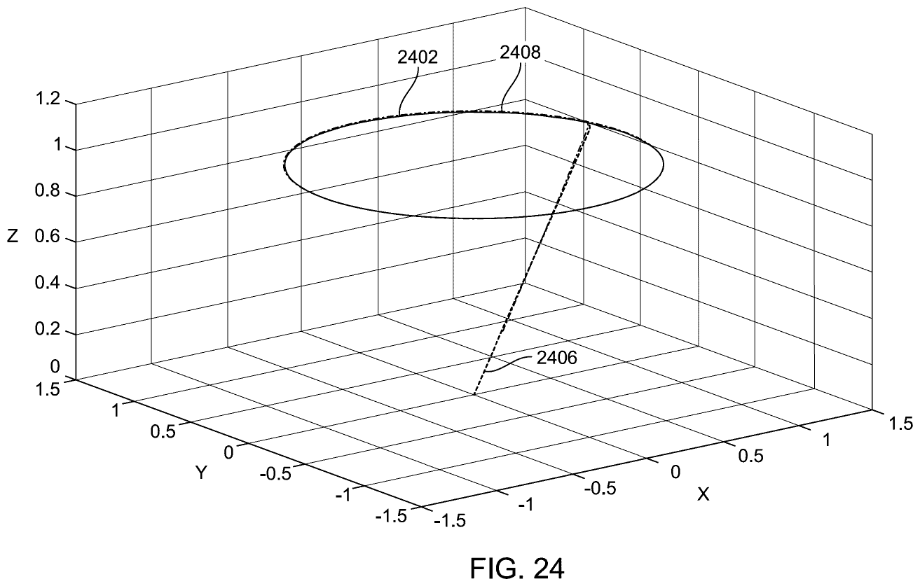

FIG. 24 illustrates a comparative analysis of the RFBL controller in both simulation and Hardware-in-the-Loop (HIL) environments for tracking a circular trajectory. The three-dimensional coordinate system is defined by the X-axis, Y-axis, and Z-axis, representing the spatial motion of the UAV. Curve 2402 represents the reference trajectory, indicated as a baseline for comparison. Curve 2406 corresponds to the RFBL controller implemented in a simulation environment, depicting the expected trajectory tracking performance. Curve 2408 represents the RFBL controller in the HIL environment, where real-time validation is performed using a microprocessor-based system. The results indicate a close alignment between the simulation and HIL implementations, demonstrating the controller's efficacy in real-time applications.

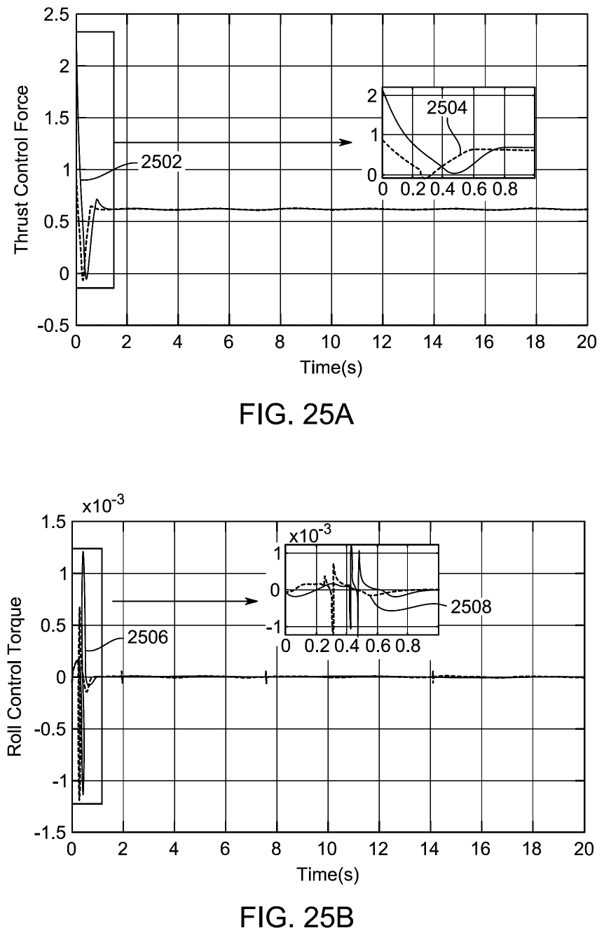

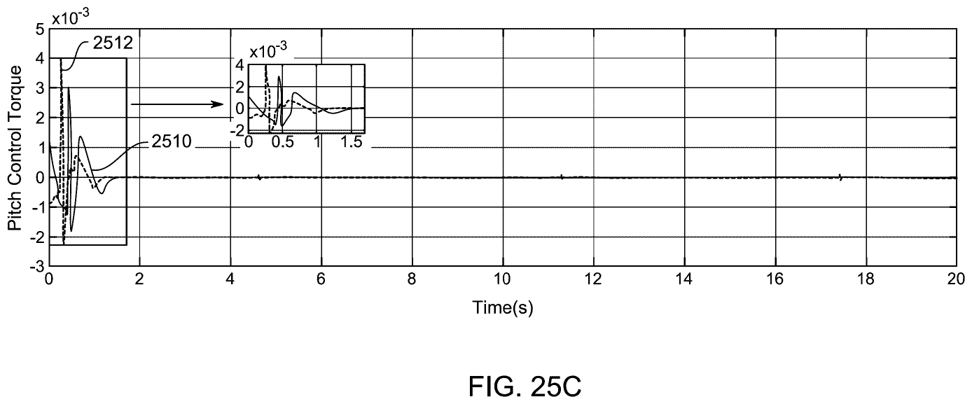

FIG. 25A illustrates the thrust control force response of the RFBL controller in both simulation and HIL environments. The X-axis represents time in seconds, while the Y-axis represents the thrust control force. Curve 2502 corresponds to the thrust control force generated in the simulation environment, and curve 2504 represents the thrust control force obtained from the HIL experiment. A transient phase is observed initially, where a slight variation between the two implementations exists. As the system stabilizes, both curves converge, indicating consistent thrust control between the simulated and real-time environments.

FIG. 25B illustrates the roll control torque response of the RFBL controller in both simulation and HIL environments. The X-axis represents time in seconds, and the Y-axis represents the roll control torque. Curve 2506 represents the roll control torque obtained from the simulation environment, while curve 2508 corresponds to the HIL implementation. The initial phase exhibits a transient response with minor deviations. As the system achieves steady-state conditions, the roll control torque follows a closely aligned trajectory in both implementations, validating the robustness of the controller.

FIG. 25C illustrates the pitch control torque response of the RFBL controller in both simulation and HIL environments. The X-axis represents time in seconds, and the Y-axis represents the pitch control torque. Curve 2510 corresponds to the pitch control torque in the simulation environment, while curve 2512 represents the pitch control torque obtained from the HIL experiment. A distinct transient phase is observed at the start, showing slight oscillations. As the trajectory progresses, both implementations closely follow the same control torque response, demonstrating the real-time feasibility of the RFBL controller in practical applications.

To replicate the controller and plant within a real-world environment, the HIL experiment was conducted. Although validation through implementation on actual hardware offers greater reliability, the constraints of limited resources necessitated the use of S-HIL. The S-HIL method approximates the controller in a real-time setting and provides a cost-effective alternative by deploying both the plant and controller on a microprocessor field-programmable gate array (FPGA).

The implementation of S-HIL (Single Hardware-in-Loop) involves discretizing continuous-time blocks in Simulink/Matlab with an appropriately selected sample time. The S-HIL was executed using the MicroLabBox dSPACE RTI-1202 platform. As demonstrated in FIG. 24, the S-HIL results exhibit effective trajectory tracking when compared to simulation results. During implementation in the S-HIL environment, a low computational burden was observed, as each disturbance observer operates as a two-state ordinary differential equation that can be efficiently solved using a discrete-time solver.

The control efforts illustrated in FIGS. 25A, 25B, and 25C exhibit minor variations during the initial transient phase. However, following the transition phase, the control efforts for both the S-HIL and simulation align closely. The Hardware-in-Loop (HIL) methodology ensures results that are suitable for future practical applications.

Comparison of various parameters is shown in Tables 17, 18, 19, and 20.

TABLE 17
Quadrotor Drone parameters
Parrot Mambo Drone Parameters

| Parameter Name | Value | Units |
|---|---|---|
| Mass, m | 0.063 | kg |
| Arm lenth, l | 0.062 | m |
| Moment of Inertia along x-axis, Iₓ | 5.8286 × 10⁻⁵ | kg · m² |
| Moment of Inertia along y-axis, I_{y} | 7.1691 × 10⁻⁵ | kg · m² |
| Moment of Inertia along z-axis, I_{z} | 1 × 10⁻⁴ | kg · m² |
| Thrust Coefficient, k_{F} | 0.01 | N/(rad²/s²) |
| Thrust Coefficient, k_{M} | 7.8263 × 10⁻⁴ | Nm/(rad²/s²) |
| Aerodynamic Coefficients, ξ_{z}, ξ_{φ}, | 0.075 | N · s/rad² |
| ξ_{θ}, ξ_{ψ}, ξₓ, ξ_{y} | | |

TABLE 18
Robust Feedback Linearization (RFBL) controller parameters.
Parrot Mambo Drone Parameters

| Parameter Name | Value | Units |
|---|---|---|
| Mass, m | 0.063 | kg |
| Arm lenth, l | 0.062 | m |
| Moment of Inertia along x-axis, Iₓ | 5.8286 × 10⁻⁵ | kg · m² |
| Moment of Inertia along y-axis, I_{y} | 7.1691 × 10⁻⁵ | kg · m² |
| Moment of Inertia along z-axis, I_{z} | 1 × 10⁻⁴ | kg · m² |
| Thrust Coefficient, k_{F} | 0.01 | N/(rad²/s²) |
| Thrust Coefficient, k_{M} | 7.8263 × 10⁻⁴ | Nm/(rad²/s²) |
| Aerodynamic Coefficients, ξ_{z}, ξ_{φ}, | 0.075 | N · s/rad² |
| ξ_{θ}, ξ_{ψ}, ξₓ, ξ_{y} | | |

TABLE 19
Integral sliding mode controller (ISMC) parameters
Controller Parameters

| Parameter | Value |
|---|---|
| k_{z}, kₚₓ, k_{py}, k_{pψ} | 2 |
| k_{φ}, k_{θ} | 4 |
| c_{1z}, c_{1θ}, c_{1ψ}, c₁ₓ, c_{1y} | 10 |
| c_{1ψ} | 8 |
| c_{2z}, c_{2ψ} | 1 |
| c_{2θ}, c_{2ψ}, c₂ₓ, c_{2y} | 3 |

TABLE 20
Terminal synergetic controller (TSC) parameters.
Controller Parameters

| Parameter | Value |
|---|---|
| w_{1z} | 10 |
| 2_{2z} | 5 |
| w_{1φ}, w_{1θ}, w_{1ψ}, w₁ₓ, w_{1y} | 1000 |
| w_{2φ}, w_{2θ}, w_{2ψ}, w₂ₓ, w_{2y} | 200 |
| T_{z}, T_{φ}, T_{θ}, T_{ψ}, Tₓ, T_{y} | 1000 |
| p₁, p₂ | 5 |
| q₁, q₂ | 3 |

The results substantiate that the RFBL controller demonstrates superior performance in comparison to the other implemented controllers. While the TSC may appear to surpass the RFBL controller in certain cases, the significant spikes in control action observed in the control effort undermine its effectiveness by inducing actuator saturation. The RFBL controller exhibits lower tracking errors, reduced settling times, and enhanced robustness against external disturbances. Furthermore, the NHDO achieves more precise estimation and tracking of disturbances relative to the finite-time disturbance observer. The validation conducted through HIL confirms the feasibility of the controller for practical implementation.

Future work will focus on implementing the controllers on an experimental drone platform to further validate the results in real-time conditions. Additionally, the inclusion of various other published controllers and their respective disturbance observers in the comparative analysis will provide valuable insights for readers. Moreover, optimization of controller parameters through meta-heuristic algorithms by formulating an appropriate objective function will be explored. Another pertinent avenue for further research involves the development of a disturbance observer for mismatched disturbances.

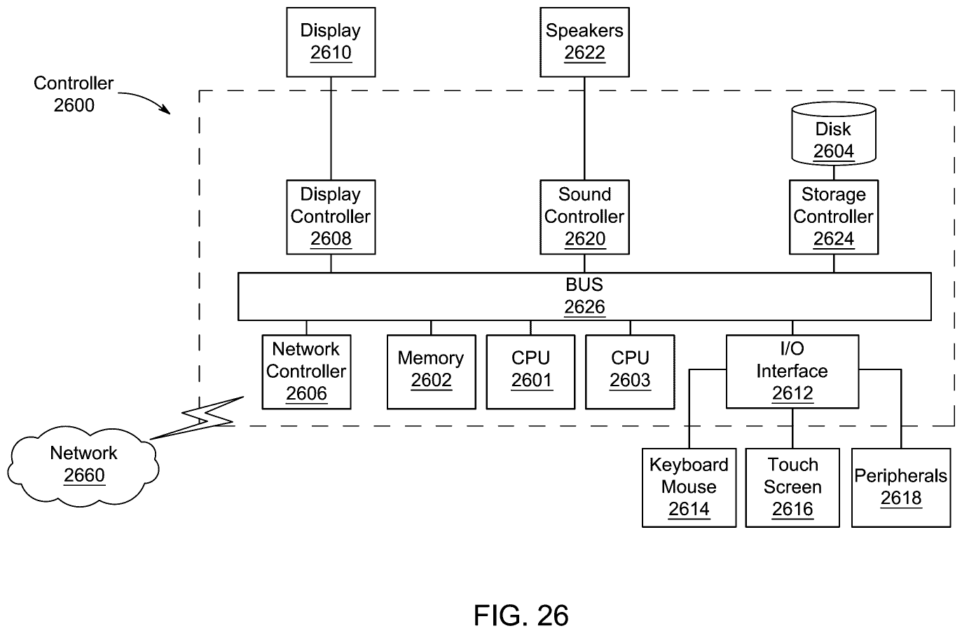

Next, further details of the hardware description of the computing environment according to exemplary embodiments is described with reference to FIG. 26. In FIG. 26, a controller 2600 is described is representative of the UAV system 100 of FIG. 1 in which the controller is a computing device which includes a CPU 2601 which performs the processes described above/below. The process data and instructions may be stored in memory 2602. These processes and instructions may also be stored on a storage medium disk 2604 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 2601, 2603 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 2601 or CPU 2603 may be a Xenon or Core processor from Intel of America or an Opteron processor from AMD of America, or may be other processor types that would be recognized by one of ordinary skill in the art. Alternatively, the CPU 2601, 2603 may be implemented on an FPGA, ASIC, PLD or using discrete logic circuits, as one of ordinary skill in the art would recognize. Further, CPU 2601, 2603 may be implemented as multiple processors cooperatively working in parallel to perform the instructions of the inventive processes described above.

The computing device in FIG. 26 also includes a network controller 2606, such as an Intel Ethernet PRO network interface card from Intel Corporation of America, for interfacing with network 2660. As can be appreciated, the network 2660 can be a public network, such as the Internet, or a private network such as an LAN or WAN network, or any combination thereof and can also include PSTN or ISDN sub-networks. The network 2660 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 2608, such as a NVIDIA GeForce GTX or Quadro graphics adaptor from NVIDIA Corporation of America for interfacing with display 2610, such as a Hewlett Packard HPL2445w LCD monitor. A general purpose I/O interface 2612 interfaces with a keyboard and/or mouse 2614 as well as a touch screen panel 2616 on or separate from display 2610. General purpose I/O interface also connects to a variety of peripherals 2618 including printers and scanners, such as an OfficeJet or DeskJet from Hewlett Packard.

A sound controller 2620 is also provided in the computing device such as Sound Blaster X-Fi Titanium from Creative, to interface with speakers/microphone 2622 thereby providing sounds and/or music.

The general purpose storage controller 2624 connects the storage medium disk 2604 with communication bus 2626, which may be an ISA, EISA, VESA, PCI, or similar, for interconnecting all of the components of the computing device. A description of the general features and functionality of the display 2610, keyboard and/or mouse 2614, as well as the display controller 2608, storage controller 2624, network controller 2606, sound controller 2620, and general purpose I/O interface 2612 is omitted herein for brevity as these features are known.

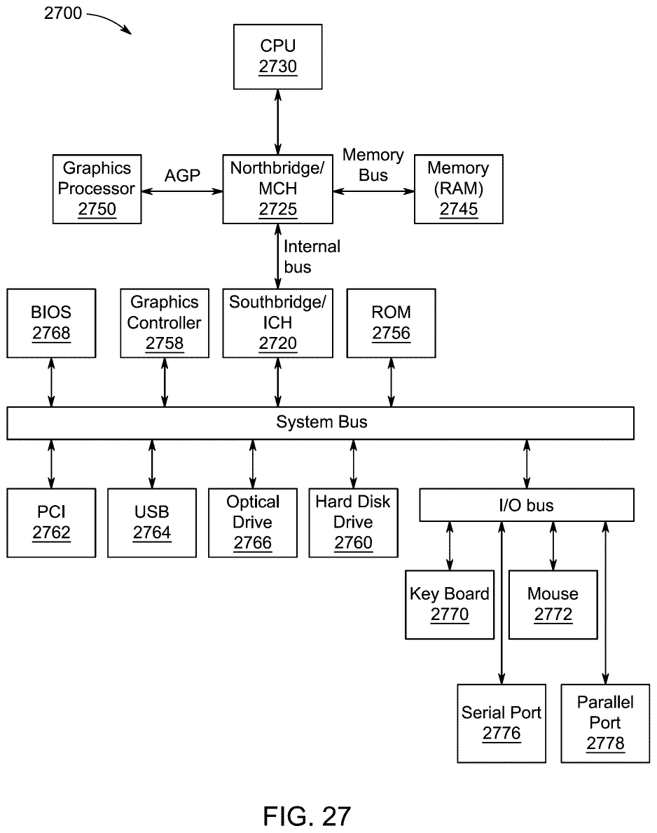

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 27.

FIG. 27 shows a schematic diagram of a data processing system, according to certain embodiments, for performing the functions of the exemplary embodiments. The data processing system is an example of a computer in which code or instructions implementing the processes of the illustrative embodiments may be located.

In FIG. 27, data processing system 2700 employs a hub architecture including a north bridge and memory controller hub (NB/MCH) 2725 and a south bridge and input/output (I/O) controller hub (SB/ICH) 2720. The central processing unit (CPU) 2730 is connected to NB/MCH 2725. The NB/MCH 2725 also connects to the memory 2745 via a memory bus, and connects to the graphics processor 2750 via an accelerated graphics port (AGP). The NB/MCH 2725 also connects to the SB/ICH 2720 via an internal bus (e.g., a unified media interface or a direct media interface). The CPU Processing unit 2730 may contain one or more processors and even may be implemented using one or more heterogeneous processor systems.

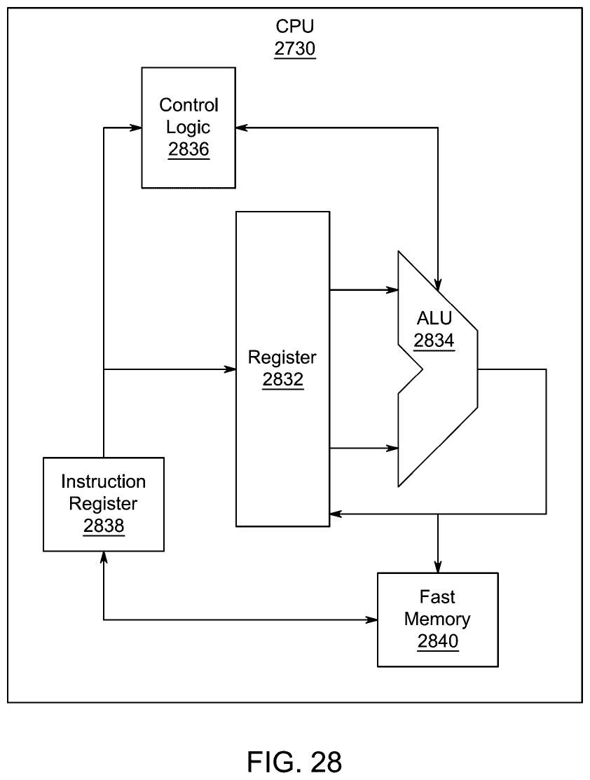

For example, FIG. 28 shows one implementation of CPU 2730. In one implementation, the instruction register 2838 retrieves instructions from the fast memory 2840. At least part of these instructions is fetched from the instruction register 2838 by the control logic 2836 and interpreted according to the instruction set architecture of the CPU 2730. Part of the instructions can also be directed to the register 2832. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 2834 that loads values from the register 2832 and performs logical and mathematical operations on the loaded values according to the instructions. The results from these operations can be feedback into the register and/or stored in the fast memory 2840. According to certain implementations, the instruction set architecture of the CPU 2730 can use a reduced instruction set architecture, a complex instruction set architecture, a vector processor architecture, a very large instruction word architecture. Furthermore, the CPU 2730 can be based on the Von Neuman model or the Harvard model. The CPU 2730 can be a digital signal processor, an FPGA, an ASIC, a PLA, a PLD, or a CPLD. Further, the CPU 7230 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 27, the data processing system 2700 can include that the SB/ICH 2720 is coupled through a system bus to an I/O Bus, a read only memory (ROM) 2756, universal serial bus (USB) port 2764, a flash binary input/output system (BIOS) 2768, and a graphics controller 2758. PCI/PCIe devices can also be coupled to SB/ICH 2788 through a PCI bus 2762.

The PCI devices may include, for example, Ethernet adapters, add-in cards, and PC cards for notebook computers. The Hard disk drive 2760 and CD-ROM 2766 can use, for example, an integrated drive electronics (IDE) or serial advanced technology attachment (SATA) interface. In one implementation the I/O bus can include a super I/O (SIO) device.

Further, the hard disk drive (HDD) 1860 and optical drive 2766 can also be coupled to the SB/ICH 2720 through a system bus. In one implementation, a keyboard 2770, a mouse 2772, a parallel port 2778, and a serial port 2776 can be connected to the system bus through the I/O bus. Other peripherals and devices that can be connected to the SB/ICH 2720 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

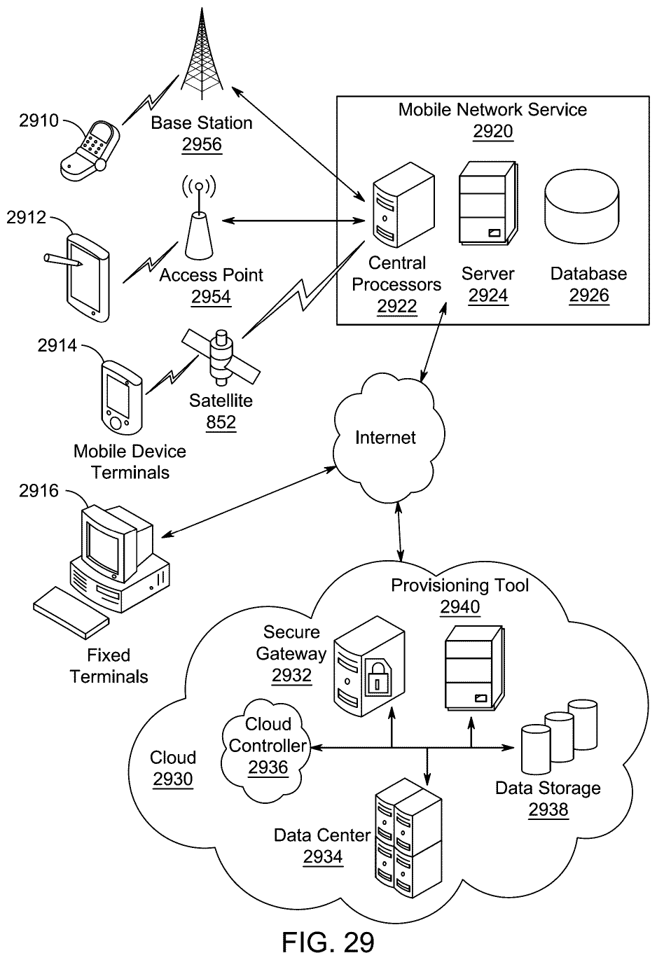

The functions and features described herein may also be executed by various distributed components of a system. For example, one or more processors may execute these system functions, wherein the processors are distributed across multiple components communicating in a network. The distributed components may include one or more client and server machines, such as cloud 2930 including a cloud controller 2936, a secure gateway 2932, a data center 2934, data storage 2938 and a provisioning tool 2940, and mobile network services 2920 including central processors 2922, a server 2924 and a database 2926, which may share processing, as shown by FIG. 29, in addition to various human interface and communication devices (e.g., display monitors 2916, smart phones 299, tablets 2912, personal digital assistants (PDAs) 2914). The network may be a private network, such as a LAN, satellite 2952 or WAN 2954, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A method of controlling an unmanned aerial vehicle (UAV) including a plurality of propellers, comprising:
setting an initial rotational speed of each propeller of the plurality of propellers;
obtaining a control input including a plurality of desired state trajectories from a user;
determining an altitude-and-attitude control action based on an X-orientation model including an input-to-state feedback linearization, an estimated disturbance, and the control input, wherein the altitude-and-attitude control action comprises a z-direction control, a roll control, a pitch control, and a yaw-axis control, wherein the control input includes a first supertwisting controller and a first sliding surface;
determining a position X-Y control action based on the plurality of desired state trajectories and the X-orientation model with a second supertwisting controller and a second sliding surface;
determining a required rotational speed of each propeller of the plurality of propellers based on the altitude-and-attitude control action and the position X-Y control action; and
changing the initial rotational speed of each propeller of the plurality of propellers to the required rotational speed of each propeller of the plurality of propellers to control the UAV.

2. The method of claim 1, wherein the X-orientation model includes a plurality of virtual control inputs to control motions of the UAV under a fully actuated system.

3. The method of claim 1, wherein the first supertwisting controller and the second supertwisting controller are represented by −k₁ⱼ|sⱼ|^{0.5}sgn(sⱼ)−k_{2i∫ sgn(s}_{ⱼ}₎, wherein the k₁ⱼ and the k₂ⱼ are gains of the supertwisting controller for an axis j, wherein the axis j is selected from the group consisting of a z-direction axis, a roll axis, a pitch axis, and a yaw axis, and wherein the sⱼ is a sliding surface of the axis j.

4. The method of claim 3, wherein the sⱼ is represented by cᵢe₂ᵢ₋₁+e₂ᵢ, wherein the cᵢ is a design constant of the axis j, wherein the eᵢ=xᵢ−xᵢ^{d}, wherein the xᵢ is a current position of axis j, wherein the xᵢ^{d} is a plurality of desired state trajectories of axis j, and wherein i=1 when the axis j is the z-direction axis, i=2 when the axis j is the roll axis, i=3 when the axis j is the pitch axis, i=4 when the axis j is the yaw axis.

5. The method of claim 1, further comprising determining the estimated disturbance acting on the UAV using a nonlinear harmonic disturbance observer (NHDO).

6. The method of claim 5, wherein the altitude-and-attitude control action determined based on the estimated disturbance acting on the UAV using the NHDO is determined by:
$${v}_{1 , new} = {\dot{x}}_{2}^{d} - {K}_{pz} {e}_{1} - {K}_{dz} {e}_{2} - {k}_{1 z} {\vert {s}_{z} \vert}^{0.5} sign ( {s}_{z} ) - {k}_{2 z} \int sign ( {s}_{z} ) dt - {\hat{d}}_{z}$$
$${v}_{2 , new} = {\dot{x}}_{4}^{d} - {K}_{p ϕ} {e}_{3} - {K}_{d ϕ} {e}_{4} - {k}_{1 ϕ} {\vert {s}_{ϕ} \vert}^{0.5} sign ( {s}_{ϕ} ) - {k}_{2 ϕ} \int sign ( {s}_{ϕ} ) dt - {\hat{d}}_{ϕ}$$
$${v}_{3 , new} = {\dot{x}}_{6}^{d} - {K}_{p θ} {e}_{5} - {K}_{d θ} {e}_{6} - {k}_{1 θ} {\vert {s}_{θ} \vert}^{0.5} sign ( {s}_{θ} ) - {k}_{2 θ} \int sign ( {s}_{θ} ) dt - {\hat{d}}_{θ}$$
$${v}_{4 , new} = {\dot{x}}_{8}^{d} - {K}_{p ψ} {e}_{7} - {K}_{d ψ} {e}_{8}$$

7. The method of claim 5, wherein the position X-Y control action determined based on the estimated disturbance acting on the UAV using the NHDO is determined by:
$$\begin{matrix}{F}_{x} = \frac{m}{{F}_{z}} ( {\dot{x}}_{10}^{d} + \frac{{ξ}_{x}}{m} {x}_{10} - {K}_{px} {e}_{9} - {K}_{dx} {e}_{10} - \\ {k}_{1 x} {\vert {s}_{x} \vert}^{0.5} sign ( {s}_{x} ) - {k}_{2 x} \int sign ( {s}_{x} ) dt - {\hat{d}}_{x} ) \\ {F}_{y} = \frac{m}{{F}_{z}} ( {\dot{x}}_{12}^{d} + \frac{{ξ}_{y}}{m} {x}_{12} - {K}_{py} {e}_{11} - {K}_{dy} {e}_{12} - \\ {k}_{1 y} {\vert {s}_{y} \vert}^{0.5} sign ( {s}_{y} ) - {k}_{2 y} \int sign ( {s}_{y} ) dt - {\hat{d}}_{y} )\end{matrix} \}$$

8. The method of claim 5, wherein the NHDO estimates the disturbance acting on the UAV using a two-state ordinary differential equations.

9. The method of claim 5, wherein the NHDO estimates the disturbance acting on the UAV by analyzing harmonic frequency components of external forces causing the disturbance.

10. The method of claim 9, wherein the NHDO rejects disturbances with predetermined frequency components.

11. The method of claim 1, further comprising
obtaining a nonlinear dynamic model of the UAV; and
applying a robust feedback linearization (RFBL) model including a supertwisting model to the nonlinear dynamic model to generate a linearized dynamic model of the UAV.

12. The method of claim 1, wherein the first supertwisting controller is added to an outer-loop controller of the input-to-state feedback linearization.

13. The method of claim 12, wherein a proportional derivative control is included in the outer-loop controller of the input-to-state feedback linearization.

14. The method of claim 1, further comprising validating the altitude-and-attitude control action, the position X-Y control action, and the required rotational speed using a Hardware-in-Loop (HIL) simulation.

15. The method of claim 14, wherein the HIL simulation is a single-HIL simulation.

16. The method of claim 1, further comprising receiving a target trajectory for the UAV.

17. The method of claim 16, wherein the target trajectory includes a target position and a target altitude.

18. The method of claim 1, wherein the required rotational speed of each propeller of the plurality of propellers is based on a determined thrust and torque.

19. The method of claim 1, further comprising receiving state data of the UAV including a position, an attitude, and a velocity of the UAV.

20. The method of claim 1, wherein a stability of the UAV is determined using a Lyapunov analysis.
